(19) United States
(12) Patent Application Publication
(10) Pub. No.: US 2008/0121690 A1
(43) Pub. Date: May 29, 2008

(54) Ubiquitous Tracking System and Method

(76) Inventors: Sherry L. Carani, Hollywood, FL (US); Cathy L. Josey, Hollywood, FL (US); Barry C. Leeper, Deerfield Beach, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/563,384

(22) Filed: Nov. 27, 2006

(51) Int. Cl. G06F 7/00

(52) U.S. Cl. 235/376

(57) ABSTRACT

The ubiquitous tracking system monitors many trackable devices from different manufacturers, each transmitting geographic locus, device id and event data via GPS, GPRS or GSM communications channels. The data is addressed to the tracking system. The system compiles device data profiles and customer profiles which correlate tracking devices with the customer. The tracking method accepts device data at a communications port, decodes the data, and correlates it with the customer profile. The system is typically an ASP model and the logged decoded data is sent to the customer's client computer as a web generated data report.

The present invention relates to a computerized method of tracking a plurality of tracking devices (such as trucks with tracking devices, fixed assets with geo trackers or other mobile assets with geo responders thereon) and a system therefor which, in general, is agnostic to the tracking device.

### BACKGROUND OF THE INVENTION

Tracking devices have been utilized for several years on mobile assets such as trucks, cars, taxi cabs and other items. These systems utilize global positioning system GPS receivers in the tracking device modem and transmit location or locus data and event data along with a tracking device identifier (id) to a receiving station. Typically, the tracking device or group of tracking devices for a plurality of mobile assets, such as trucks for a certain transport company, are uniquely coded to the receiving central control station in that the control station rarely obtains tracking signals from a wide variety of tracking devices made by a wide variety of manufacturers.

### OBJECTS OF THE INVENTION

It is an object of the present invention to provide a ubiquitous computerized method for tracking a wide variety of tracking devices from a number of tracking device manufacturers and provide a unique tracking control center and method enabling the customer to customize display panels or screens for the customer's monitors showing the tracked items, messages, alerts and various reports which can be further downloaded and transmitted as needed by the customer.

It is another object of the present invention to provide a method for tracking wherein the user selects, on the display monitor, which language the information is presented to the user. The user can seemlessly switch display languages for the same display screen.

It is a further object of the present invention to enable the user to show the same display reports in two languages, at the same time, on two browser screen displays.

It is a further object of the present invention to provide a dynamic display for tracking device data on a monitor wherein the user selects the time zone for the display and all displayed data is thereafter altered to match the selected time zone.

It is a further object of the present invention to provide a dynamic display for tracking device data on a monitor wherein the display shows a plurality of action and report selection tools including, in various combinations, initiating a polling or ping signal to the selected tracking device, displaying a historic report spanning a predetermined period of time (bread crumb trail), initiating a message signal to the specified tracking device, displaying historic report for the tracking device, displaying the current location of the tracking device and other tracking devices within the geographic boundaries of the displayed map, and displaying the selected tracking device and a geo fence or predetermined geographic limits associated with that tracking device on the map.

It is an additional object of the present invention to provide a series of displayable maps which are hierarchically classified such as regional, state, city maps and further classified with a site or yard map. The display of the tracked device shifts to the next hierarchical map upon transit over geographic boundaries.

It is an additional object of the present invention to provide a geographic limiting system wherein the ubiquitous tracking method and system issues an alert when a tracking device transits over a substantially closed, user definable geographic limit, that is, a geo fence defined by the user.

### SUMMARY OF THE INVENTION

The ubiquitous method of tracking and tracking system monitors a plurality of trackable devices, each logging and transmitting geographic location or locus data and device id unique to the tracking device. These tracking devices transmit independent communications packets via GPS, GPRS or GSM communications channels. Each communications packet includes addressee data, unique tracking device id data and a logged locus data either periodically or upon event detected or monitored locally by the tracking device. As initially setup, the tracking system and monitor control center compiles tracking device data communications profiles for the plurality of tracking devices manufactured by a sub-plurality of tracking device manufacturers. Each tracking device has a data communications profile which includes data field identifiers for the device id data and the logged locus data and at least event condition data field. The tracking method and system also compiles, as part of the setup, a plurality of customer profiles which correlates sub-pluralities of tracking devices with a corresponding customer. Within each customer profile, the tracking device is further correlated with sub-pluralities of trackable assets owned, controlled or under surveillance by the respective customer. The tracking method and system accepts at a communications port corresponding to the addressee data, the plurality of tracking device communications packets. The system decodes these communications packets to ascertain data fields for the device id data, the logged locus data and at least one event condition. The decoded data is correlated with the customer profile and per the customer tracking device. The system logs and records decoded data as per the customer profile and then reports the logged decoded data as requested in the customer profile. Preferably, the tracking monitor and system is a web based system wherein the server compiles the data communications profile, compiles the customer profile, accepts the communications packets, decodes these packets, correlates the decoded data, logs and records the decoded data and sends to the customer's client computer a web generated data report reporting the logged decoded data.

The multiple language selector as deployed by the computerized method for the dynamic display of the tracking device data includes compiling associated tracking device data which includes asset data associated with the tracking device, driver data associated with that device, asset load condition data, speed data, direction data, event code data received from the tracking device, messages received from the tracking device, messages sent to the tracking device and the party owning or controlling the tracking device. The system can dynamically switch between at least two languages (e.g. English and Spanish) as selected by the user during the display of the data. Either data translation profiles for each of the words or phrases in the initial display is utilized by the tracking monitor or system or a phraseology dictionary lookup data table in the two languages utilized. Labels for the data fields on the display are also translated between the two languages as requested by the user. The user may also open two browser displays (since the present system is a web based Application Service Provider (ASP)), and display the data in both the first and the second languages concurrently.

One aspect of the present invention for the dynamic display of tracking device data includes employing a time zone selector. Therefore, the organized data is displayed on the customer's monitor in one time zone (EST) and, upon the selection of the user, a second time zone (MST) is shown and all the displayed data is converted from the first time zone to the second time zone. Typically, the time stamp data from a tracking device is stored in a common time format such as Greenwich Mean Time GMT. The tracking monitor system and method converts the GMT or common time format for each of the timed events and it converts other GMT records to a local time for the system such as Eastern Standard Time EST as per a user's display command initially set as a profile in the customer profile or as requested during set up of the system. The system displays a “time zone selector” such that the user can switch from the local time zone to a different time zone, such as GMT or Pacific Standard Time PST upon command. All the data displayed on the browser-organized data display is changed to reflect the selected time zone. By opening two browsers, the user can see on two different monitors or switch between the two display screens on the same monitor showing the different time zones. All other data formats remain the same except the time (and date change, if appropriate).

The computerized method for the dynamic display of tracking device data and the system also includes an asset tool bar. One of the organized data displays shows various combinations of tracking device id data, geographic description data for the locus data, event description, message data, event time, asset association, driver data, asset load condition, speed, direction, messages received, messages sent or the party owning or controlling the tracking device. This data display also includes an asset tool bar showing a plurality of action and report selection tools. These actions and report selection tools, when selected by the user on the dynamic display, initiate various actions and selections such as: initiating a polling or ping signal to the tracking device, displaying a historic report over a period of time (all tracking records over 2 days, for example), initiating a signal to the tracking device, displaying a historic route overlaid upon a map which map is customer selectable (bread crumb trail), displaying the current location of the tracking device imposed on a map in addition to other selective tracking devices owned or controlled by the same party or organization, and/or displaying the current location on a map and also displaying the geographic limit imposed by the system on the map for that tracking device, that is, a geo fence.

The computerized method for the dynamic display of tracking device data and system also includes a map shifting function. The system compiles a series of displayable maps generally hierarchically classified such as by region, state and city geographic data defined boundaries. Further, a site or yard map is also geographically defined with data defined boundaries. When a tracking device transits from one hierarchically classified map into a lower classified map or from a lower map to a higher map, the system automatically changes the display from one map to the other map based upon the last obtained geographic tracking data representing the locus data from the tracking device.

The computerized method for dynamic monitoring and display of tracking device data and the system also includes a geo fence and an automatic alert. The system has user defined geographic limit settings which establish programmable geographic data defined boundaries on maps. These boundaries have a substantially closed shape and are overlaid on displayable maps. When the tracking data from the tracking device transits or crosses the substantial closed shape for the user defined geographic limits, an alert message is automatically generated. Further, the system can be programmed to initiate a time-in or time-out function when the tracking device crosses the geo fence and the time (time-in or time-out) exceeds a predetermined time parameter or temporal limit. The alarm is subsequently issued or a further alarm is issued when the temporal limit is exceeded by either ingress or egress with respect to the geo fence and the tracking device.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates an overview of the tracking device system and various tracking devices and mobile assets and monitored buildings;

FIG. 2 diagrammatically illustrates a number of tracking devices on a singular vehicle which, in combination, may be generally defined as a mobile asset;

FIG. 3A diagrammatically illustrates various components of a tracking device;

FIG. 3B diagrammatically illustrates a single mode modem;

FIG. 3C diagrammatically illustrates a dual mode modem;

FIG. 4 diagrammatically illustrates the data collection by a tracking device, the collection of that information by the tracking control center and the report generation and display generation of tracking data to various customers of the tracking control center;

FIG. 5 diagrammatically illustrates the major functional modules of the computerized method;

FIGS. 6A and 6B diagrammatically illustrate major functional modules in the administration or admin center for the present invention;

FIGS. 7A and 7B diagrammatically illustrate the major functional modules of the tracking center;

FIG. 7C illustrates mapping features; and

FIGS. 8A and 8B diagrammatically illustrate the major function modules for the back office of the present invention.

### DETAILED DESCRIPTION OF THE PREFERRED EMBODIMENTS

The present invention relates to a ubiquitous tracking method and system wherein many different types of tracking devices, from may different manufacturers are tracked in a single, ASP based tracking communications center. The user-customer can configure the tracking displays in a wide variety of ways. Important features of the system and method include the ubiquitous nature of the system, the ability of the system to be changed or configured per a customer request to match or mimic the customer's existing system, the ability of the tracking method and system to accept data from legacy tracking devices and data from legacy tracking systems, the re-packaging of that data as per customer profiles and provide dynamic reports which are downloadable directly into management spread sheets and data bases. Other important features are the switchable nature of the display language. The user-viewer can switch from English to Spanish and back with the same display and formatted data. The system also includes a time zone selector such that the user-viewer can select an entire display in one time zone, then switch seamlessly into another time zone. Multiple browser or display panels can be opened by the user simply by opening a second browser. In this manner, the user-viewer can have the same data on two different screens in (a) two different languages and/or (b) two different time zones.

The system also includes an asset tool bar which enables the user to quickly go between the currently displayed screen and an action or report screen such as sending a polling signal or a ping to the tracked device, initiating a message signal to the tracked device, or enables the user to display a historical tracking device data, display a historical route for the device, display the current location of tracking device imposed upon a user selectable (pre-selected) map, or enables the user to display the tracking device on the map with further predetermined geographic limits or geo fence. In a further embodiment, the user is permitted to shift between tracking maps and, when the tracked device crosses a geographic data defined boundaries from one hierarchical map to another such as from region, state, city to site or yard, the system automatically shifts to the lower level hierarchical map or higher level (dependent upon whether the tracked asset is moving into the lower map or out of the lower map). A geo fence is also established which sends an automatic alarm signal when the tracked item transits the substantially closed shape which is programmably determined by the user as a geographic defined boundary for the tracked device.

### General System and Method or Process Comments

It is important to know that the embodiments illustrated herein and described herein are only examples of the many advantageous uses of the innovative teachings set forth herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts or features throughout the several views. The section titles are not meant to limit the detailed description of the system and process described therein.

The present invention could be produced in hardware or software, or in a combination of hardware and software, and these implementations would be known to one of ordinary skill in the art. The system, or method, according to the inventive principles as disclosed in connection with the preferred embodiment, may be produced in a single computer system having separate elements or means for performing the individual functions or steps described or claimed or one or more elements or means combining the performance of any of the functions or steps disclosed or claimed, or may be arranged in a distributed computer system, interconnected by any suitable means as would be known by one of ordinary skill in the art. The tracker server is communicatively coupled to the client applications on several client computers. Client computers are owned or operated by customers, re-sellers or agents.

According to the inventive principles as disclosed in connection with the preferred embodiment, the invention and the inventive principles are not limited to any particular kind of computer system but may be used with any general purpose computer, as would be known to one of ordinary skill in the art, arranged to perform the functions described and the method steps described. The operations of such a computer, as described above, may be according to a computer program contained on a medium for use in the operation or control of the computer as would be known to one of ordinary skill in the art. The computer medium which may be used to hold or contain the computer program product, may be a fixture of the computer such as an embedded memory or may be on a transportable medium such as a disk, as would be known to one of ordinary skill in the art.

The invention is not limited to any particular computer program or logic or language, or instruction but may be practiced with any such suitable program, logic or language, or instructions as would be known to one of ordinary skill in the art. Without limiting the principles of the disclosed invention any such computing system can include, inter alia, at least a computer readable medium allowing a computer to read data, instructions, messages or message packets, and other computer readable information from the computer readable medium. The computer readable medium may include non-volatile memory, such as ROM, flash memory, floppy disk, disk drive memory, CD-ROM, and other permanent storage. Additionally, a computer readable medium may include, for example, volatile storage such as RAM, buffers, cache memory, and network circuits. Furthermore, the computer readable medium may include computer readable information in a transitory state medium such as a network link and/or a network interface, including a wired network or a wireless network, that allow a computer to read such computer readable information.

The functional elements of the processes and computer programs described herein may be re-organized to optimize performance or comply with hardware limitations or interconnectivity with software platforms and master programs. In fact, the general descriptions and detailed descriptions employ the functional elements in different orders of operation.

In the drawings, and sometimes in the specification, reference is made to certain abbreviations. The following Abbreviations Table provides a correspondence between the abbreviations and the item or feature.

ABBREVIATIONS TABLE

| | |
|---|---|
| Admin | administration |
| Alm | alarm, audio or visual or combo, such as trig alm |
| ASP | application service provider - server on a network |
| B to B | business to business data or data transaction |
| bd | board, typically, a board in a computer or |
| | programmable system |
| box | container, barrel or other item used to carry or transport |
| | a tangible object sought to be tracked |
| C1 | designation for computer C1, C2, etc. |
| ch | channel, such as comm ch and communications channel |
| comm. | communications, typically telecommunications |
| comp | computer |
| contlr. | control or controller such as Customer Control Center |
| cnt | count such as time count down |
| CPU | central processing unit |
| DB | database |
| D.Bd. | daughter board |
| disp | display |
| doc | document |
| F | when used in a table for display screen, a function or |
| | hot action button |
| GPS | global positioning system |
| GPRS | general packet radio service |
| GSM | type of tracking signal and type of communications channel |
| | used by some cell phone services |
| HR | human resources |
| I/O | input/output |
| id | identifier |
| invt | inventory |
| l | level, such as levels or floors in a building 11, 12 . . . 16 |
| LR asset | low range asset which should no move beyond a certain |
| | geographic boundary |
| MDT | Mobile Data Terminal |
| mem | stable or volatile memory as needed by the computer-enabled |
| | device |
| mem | memory |
| mod | modules, typically software modules, but may be hardware |
| | modules |
| ntwk | network as in “comm ntwk” - communications network |
| pgm | program |
| Pgm Cntlr | programmable controller, such as a PLC |
| PO | printed out document |
| rcr | receiver |
| req | request |
| rf | radio frequency |
| RFID | radio frequency identification device |
| rpt | report |
| s | sensor as in an RFID, GPS-GPRS sensor, etc., may be a load |
| | condition sensor, such as a door open sensor, may be an |
| | access logger which logs a PIN id to open a lock/latch, |
| | speed sensor, environmental |
| | sensor (fire, water, smoke, etc.) |
| sat | satellite |
| sch | search |
| Sec Co. | security company charged with an obligation to monitor the |
| | security of a building, vehicle, person, ship or thing |
| sys | system |
| t | time |
| teleco | telephone company which may be land lines, cell phone lines, |
| | satellite or other communications channels |
| tele-com | telecommunications system or network |
| Trkr | tracker as in Trkr 1, 2, . . . 847 |
| txr | transmitter-receiver unit |
| URL | Uniform Resource Locator, x pointer, or other network locator |
| vid | video or video image |

### Tracking System in General

The ubiquitous tracking system and computerized method is operable with a large variety of telecommunications carriers sometimes called “transport carriers”, a large number of companies manufacturing tracking hardware devices, companies that tie in data from those tracking devices, and wireless technology companies with systems which are deployed at a local level with a tracking device to indicate the presence and sometimes the local or short distance movement of the tracking device.

The ubiquitous tracking system and method is designed to work with the following transport technologies.
Transport Technologies Which Interface With System
Satellite: LEO's (low earth orbit), GeoFixed—narrow and broadband
Digital Cellular: CDMA, GPRS—GSM
Analog Cellular: Cellemetry
RF, Wi-Fi, Blue Tooth, Zigby

In addition, the tracking devices available to be monitored by the tracking system include a wide variety of items. In addition to typically tracked items such as vehicles, trucks, containers loaded on trucks, containers loaded on ships, containers in transit and in storage in yards, sites and ports, the present invention can also track a plurality of personal items, that is, virtually anything that can carry a tracking device or RFID.

TRACKING DEVICE TABLE

| | |
|---|---|
| Personal Tracking | GSM/GPRS enabled phone, |
| | enabled computer, enabled PDA, device with geo signal sensor and location transmitter |
| | On Demand - Panic alert, GSM/GPRS enabled phone, device |
| | Mounted in/on person, portable object carried by person, personal vehicle, boat, movable object, |
| | fixed object |
| Home Security door | window - electronic status of system - video - image capture and monitor |
| Building Security | Condition security, environmental condition, operational condition, foreseen - unforeseen event |
| | capture - report - alarm |
| National/International Commercial | Vehicles, boats, ships, containers, boxes, objects therein |
| Tracking | Container operation, status, lock status, location, access log, flow or meter readings |
| Mobile Assets | Trucks, vans, commercial vehicles, containers, movable storage containers - barrels - critical objects |
| Fixed Assets | monitor stationary position, position within pre-defined geo-perimeter, status |
| | condition and status monitor |
| | condition alert based upon environment, operational status, foreseen but non-schedulable |
| | event |

In general, the minimum data obtained from the tracking device is the device id, the geographic location or locus data for that tracking device, a time stamp associated with the locus data acquisition or a time stamp associated with the event code or message. The device communications packet must also include an addressee or data destination code or marker. Sometimes, the time stamp represents the event code such as when a certain tracked asset passes a sensor or sensory boundary. For example, a tracked asset may be a valuable computer which should not be moved outside of a single room. A sensory system detects when the computer is moved through a doorway monitored by some type of tracking device. The door may cause the tracker to activate. In this situation, the device id, geographic location and time stamp would indicate the event such as the removal of the computer.
Minimum Data from Tracking Device
   device id
   geographic location or locus data
   time stamp
   event code or message
   addressee

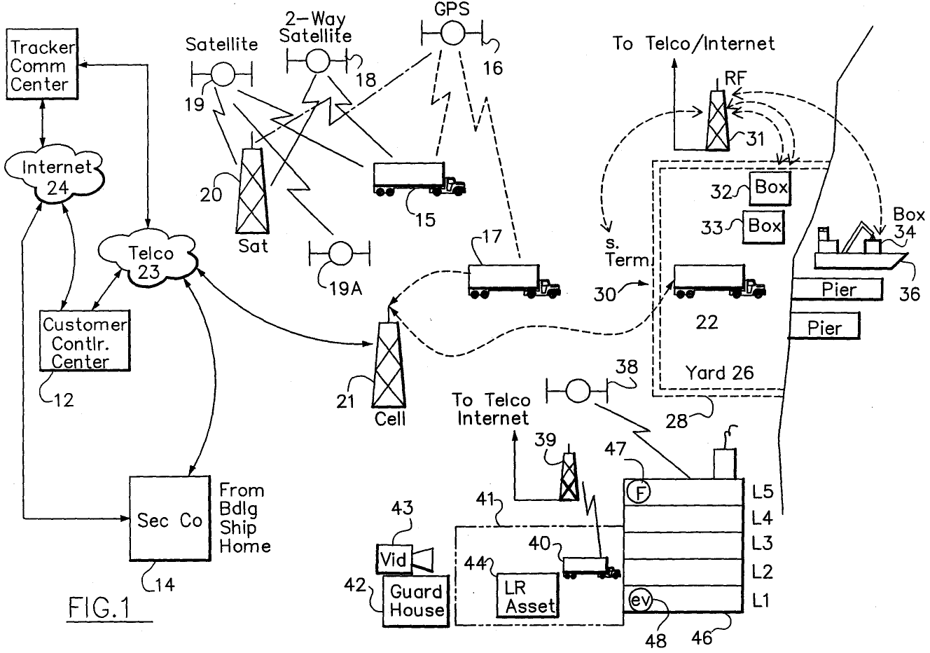

FIG. 1 diagrammatically illustrates the overall system with a plurality of tracking devices each generally reporting to tracking communications center 10. The command center or communications center 10 integrates with a variety of tracking devices, enabling dynamic, real time tracking and management of people, vehicles and other valuable assets all in a single platform. The tracking communications center 10 is an Application Service Provider (ASP) generally employing a web site server which outputs data screens and data reports to its customers, one of which is customer control center 12 and a second of which is security company 14.

In prior art systems, customers would typically deploy multiple tracking devices from a single manufacturer using a single device technology and utilize a single computer system or application on their respective computers. The singular application did not function well with other type of tracking devices. Sometimes these companies employ multiple device technologies all with different, non-compatible back office and reporting systems.

The operational theory of tracking communications center 10 is to provide a flexible, cross platform system wherein customers have all their tracking needs serviced by a single, user friendly operating system. Asset and security managers at the customer's location have complete control and access to their entire enterprise. The robust platform provided by the tracking communications center 10 enables the customer to collect any and all of the customer's tracking data to a single software platform that can be easily customized by the customer to match the look and feel of his or her existing business and enterprise system. For customers employing older tracking device technology, or those using multiple tracking device platforms for multiple manufacturers, the tracking communications center 10 can be configured to consolidate and replace these multiple platforms and displays. The present system provides the following innovative features:
Mobile Resource Management
Mobile Vehicle and Asset Tracking
System Innovations
Wireless Asset Security Systems
Logistic Management
Fleet Management System
Personal Tracking Security Devices
Workforce Automation
Mobile M2M Communications

FIG. 1 diagrammatically illustrates many types of tracking devices and mobile assets. For example, trucks 15, 17 receive GPS signals from GPS satellite 16. These trucks 15, 17 may report back via the tracking devices and two way satellite 18 or satellite 19 to a satellite tower 20. Alternatively, as shown with respect to truck 17, a GPRS signal may be sent to tower 21. The same is true with respect to truck 22 which also receives GPS signals. GSM tracking channels are also employed to carry locus data. These tracking communications signals from the tracking devices include addressee data ultimately directed to tracking communications center 10, a tracking identification or id device data, locus data, a time stamp and typically an event code or message. More sophisticated tracking devices generate and transmit two way messages to and from tracking communications center 10 via the cell phone tower 21, telephone communications or teleco system 23, and possibly internet 24. As discussed in detail below, the tracking communications center 10 reformats this data in various display reports and outputs reports and provide those reports to its customers, one of which is at customer control center 12 accessible to the tracking communications center 10 via teleco 23 (dedicated line) or more typically through internet 24. Also, security company 14 may be a customer of tracking communications center 10 wherein the security company 14 obtains data from its customers relative to building security, ship security, home security and the tracking comm center 10 reformats data for Sec Co 14. In other words, home security systems can be employed and information recorded, monitored and forwarded via the tracking communications center 10 as long as at least one of the items being tracked by the security company 14 is a geo trackable item.

Further, the tracking system can be configured to determine whether truck 22 has passed into a yard 26 defined by a user definable fence 28. User definable fence is sometimes called herein the geo fence. Further, truck 22 may be sensed by sensor terminal S and video camera 30. A signal may be sent along with a captured single video image to radio frequency tower 31 and ultimately to the telephone or teleco communications 23 or internet 24 and ultimately to tracking communications center 10. Multiple images to store and forward rely upon communications channels with more bandwidth. Further, container boxes 32, 33 may carry tracking devices that can either be pulled by polled or pinged by tracking communications center 10 via the satellite network or radio frequency network or cell phone network in order to determine or confirm the location of box, container, or objects 32, 33. As shown in FIG. 1, these boxes should be within the confines of geo fence 28 which is graphically illustrated and displayed at tracking communications center 10 but also is represented by a series of user defined programmable data points at the tracking center. Further, box or container 34 on ship 36 may be monitored. Hence, a container on a particular box can be monitored when it is on the ship, when it is stored in the yard or site as per containers 32, 33 and when those containers are put on vehicle 22 and shipped to various locations as tracked in transit by satellite systems 16, 18, 19 and 19a. Of course, a cell phone GSM system can be employed as discussed above in connection with truck 17 and cell phone tower 21.

FIG. 1 also shows the use of satellite 38 and RF tower 39 to track vehicle 40 within yard or site 41. Guard house 42 may include video camera 43 which captures an image or an event signal when truck 40 or low range LR asset 44 moves outside of parameter 41. These events are also reported to the teleco or internet via tower 39 and ultimately to tracking communications center 10. Building 46 includes multiple floors or levels L1-L5. A tracked asset may be a fixed asset as noted by sensor S 47 which the tracking communications center notes should also stay within the geographic confines of building 46. Further, a sensor EV 48 (coupled to an asset or person) may be permitted to move in the various levels of building 26, that is from level L1 to level L3 but not permitted to exit building 46 or exit the perimeter 41 defined by the user-defined geo fence in tracking communications center 10. EV 48 may be a security badge on a visitor in building 26. In this sense, the communications center 10 may track elevation sensor EV 48 within the building through its various elevational levels L1-L5 without alarm. Hence, the tracking system not only tracks the lateral and longitudinal position of the trackable device but also the elevational position within a building based upon sensors placed in the building or RF signals from the EV 48 tracking device.

The system herein is not meant to be limited to any particular tracking device but is meant to be ubiquitous to operate with a wide variety of tracking devices without being dependent upon the data format and the information coming in. If large amounts of data are scheduled to be sent from the tracking device or sub-station routing many tracking signals, a more robust communications channel may be employed such as T1 land line, internet tunnel or dedicated telecommunications line. If small amounts of data are to be sent such as tracking device id, locus data event and time stamp, those small data packets can be transmitted via a wide variety of communications channels including satellite, GSM, GPRS as well as RF signals sent locally and redistributed ultimately to tracking communications center 10.

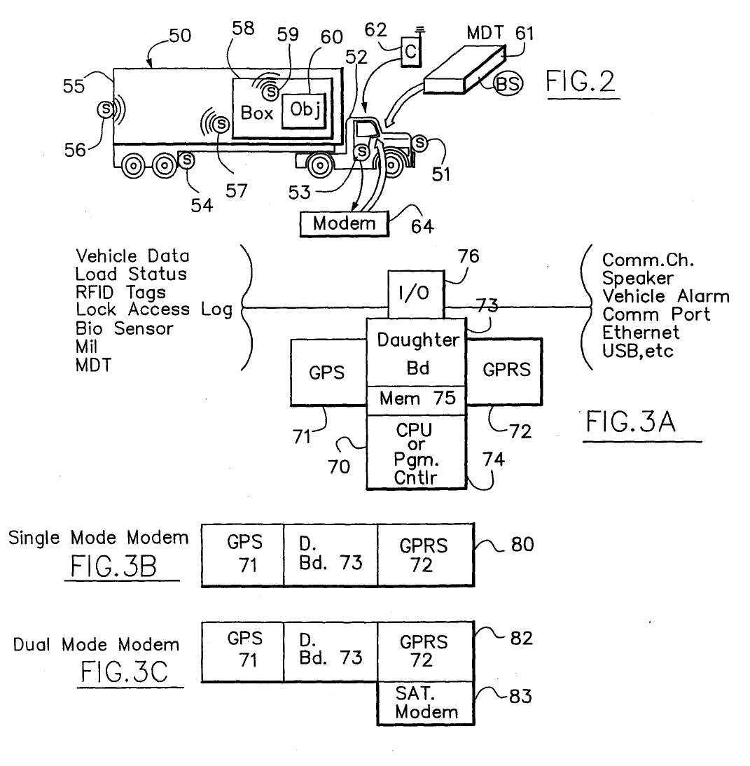

FIG. 2 shows a truck 50 having a plurality of sensors S located thereon. Sensor S 51 detects the diagnostics of the engine of tractor unit 52 of truck 50. Sensor 53 detects the speed or stop and go of truck 50. Sensor 54 detects that container 55 is always maintained on the bed of the truck. Sensor 56 determines when the back door of the truck is opened. Sensor 56 may have a access log memory and require a PIN or biometric to open. This data is forwarded to modem 64. Sensor 57 detects when the door of the container box 58 is opened. Sensor 59 detects any movement of object 60 in the container. Relative movement of S57 and S59 may signal an event. Mobile data terminal 61 is typically placed in the cab of tractor 52 and is generally operable by the driver or passenger in the truck. Mobile data terminal (MDT) 61 may include a plurality of data input and output ports such as USB ports, serial printer ports, internet ports, bluetooth, Wi-Fi, lan, wan or cell phone comm ports, etc. such that the data can be uploaded, downloaded and output from MDT 61. In addition, the driver of truck 50 may have a GSM cell phone 62 to enhance his communications with a central station or shipping operation. Tracking device or modem 64 communicates with all of these devices, sensors 51, 52, 53, 54, 56, 56, 59 as well as MDT 61. Various wireless and wired communications routine can be employed with respect to the sensors, the MDT and the modem as is known in the art. Further, MDT 61 may enable a bio sensor capture routine for the driver such as a fingerprint or voice recognition function to authorize any particular event. Events might be (a) arrival at destination, (b) exiting a destination, (c) opening or closing trailer 55, (d) off loading or loading container box 58 or (e) movement of objects 60 with respect to sensors 57 or 56. The absence of a bro sensor data capture and confirm by comm center 10 may set off an audible alarm or disable the vehicle. Additional reporting to comm center 10 is contemplated. Signature capture is also possible with respect to MDT 61. Rather than employ an MDT, the system may also employ a PDA or personal data assistant.

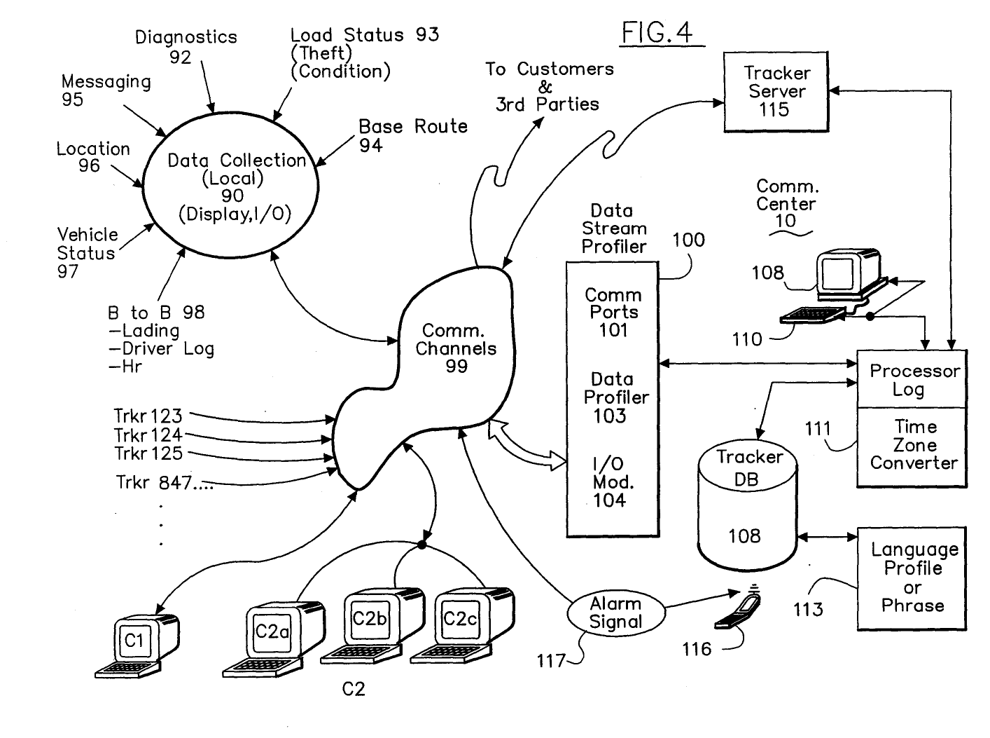

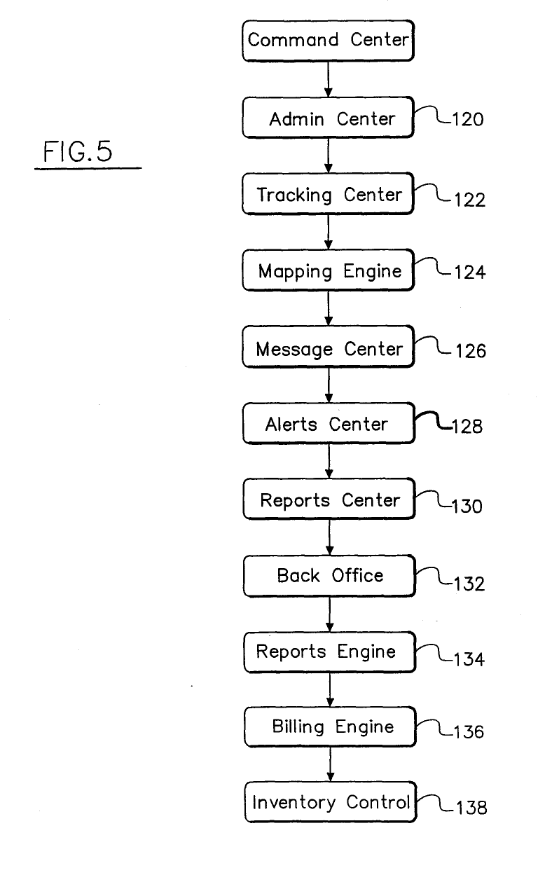

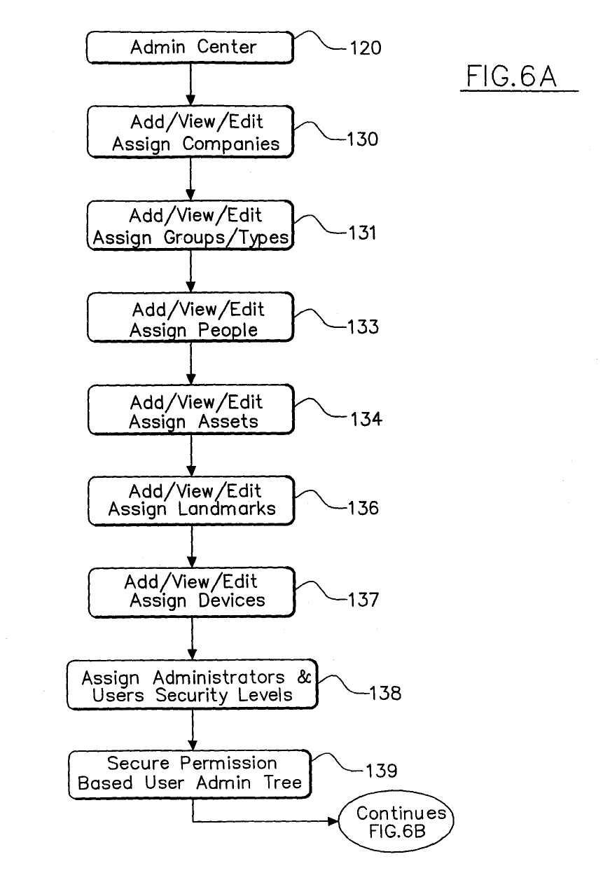

FIG. 3A diagrammatically illustrates one type of tracking device 70. Tracking device 70 includes a GPS receiver 71 and a typically a GPRS transmitter/receiver 72. A daughter board 73 is coupled to these devices and a CPU or programmable controller 74 operates in conjunction with memory 75 to enable operations such as event logging, locus data acquisition and communications to and from ultimately tracking communications center 10. Input/output unit 76 accepts vehicle data, load data, RF id tags, lock access log data, lock event data, bio sensor, voice information from microphone and information from MDT 61. Output includes information to various telecommunications channels (for example GPRS or GSM cell phone or other outgoing communications channels), a speaker to inform the driver or person in immediate vicinity of truck 50, a vehicle alarm, a communications ports including but not limited to internet, USB and others.

FIG. 3B shows a single mode modem 80 which employs GPS 71 for locus data acquisition and GPRS 72 for outbound and potentially inbound communications as well as daughter board 73. The dual mode modem is shown in FIG. 3C as modem 82. Dual mode modem in FIG. 3C includes GPS 71, GPRS 72, daughter board 73 and a satellite modem 83. In this manner, the tracking device can switch automatically from a GPRS telecommunications system to a satellite communications system generally shown in FIG. 1 in conjunction with satellite 18.

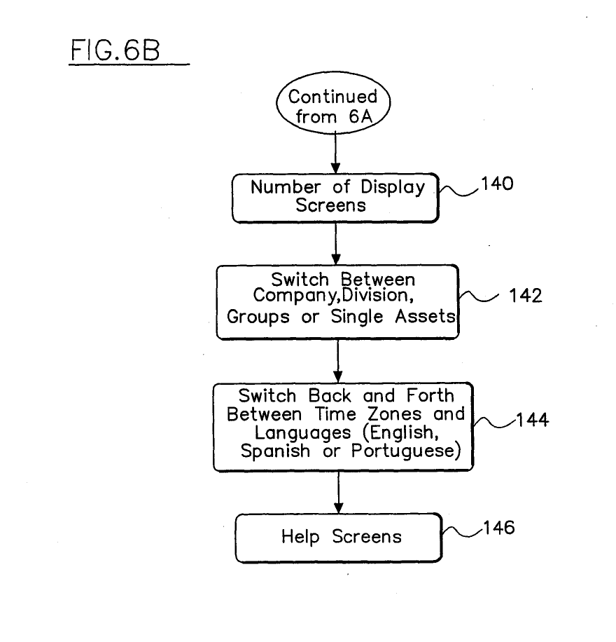

FIG. 4 diagrammatically illustrates the general aspects of the system, data flow, data acquisition and processing for tracking comm center 10. Data collection occurs locally at the tracking device and generally can be identified as data collection function 90. This local data collection by the tracking device includes local diagnostic data 92 (vehicle performance, condition), load status 93 (which may include theft event or condition or other preprogrammed event), base route information 94, messaging 95, location 96, vehicle status 97 and various business to business or B-to-B functions 98 including bills of lading, drivers logs, and human resource or HR information. Accordingly, data collection function 90 also includes an output display as well as various input and output I/O functions. The local data collection 90 by the tracking device or modem is ultimately linked via various communications channels (see FIG. 1) to the tracking comm center 10. A plurality of tracking devices, generally identified in FIG. 4 as Trkr 123, 124, 125 and Trkr 847, send communications packets with addressee information to tracking comm center 10. A data string profiler 100 includes a plurality of communications ports connected to the communications channels represented by element 99 in FIG. 4. These communications ports link to comm channels which include dedicated telecommunications lines, VPN or virtual private network, tunnels established in internet connection, dedicated phone lines, and other systems. Data string profiler 100 includes a data profiler system 103 and various input and output modules 104. The profiler 103 decodes tracking data in communications packets. The communications center also includes one or more processors 106 coupled to a data structure illustrated herein as tracker database 108. The processor correlates inbound and outbound data with records in the data structure in the tracking record database. Processor 106 enables the administrator at comm center 10 to view one or more display screens on monitor 108. Keyboard or other data input device 110 enables the system administrator to alter the data and monitor the data. Processor 106 includes various functions which are described herein but include time zone converter 111. Language profile or phrase dictionary tables 113 are associated, in a general sense, to the data structure or tracker database 108. Processor 106 also operates in conjunction with tracker server 115. The server 115 is connected to communications channel 99 and enables customers of communications center 10 to access, in real time, the reports and data. The client reports and data are created by output report-display generators configured as software modules. Client applications operate on customer computers C1 and customer computers C2a, C2b and C2c. Customer C2 views reports on various monitors or different screens (a, b, c) showing different time zones and different languages as described later. In some situations, the comm center 10 issues an alarm which is significant to management. That alarm may be externally transmitted via communications channel 99 to various devices carried by management such as cell phone 116. Rather than send alarm signal 117 to cell phone 116, the signal may be an email signal to a computer, PDA, pager or any other type of alarm device carried by the relevant management person.

### General Functional Modules

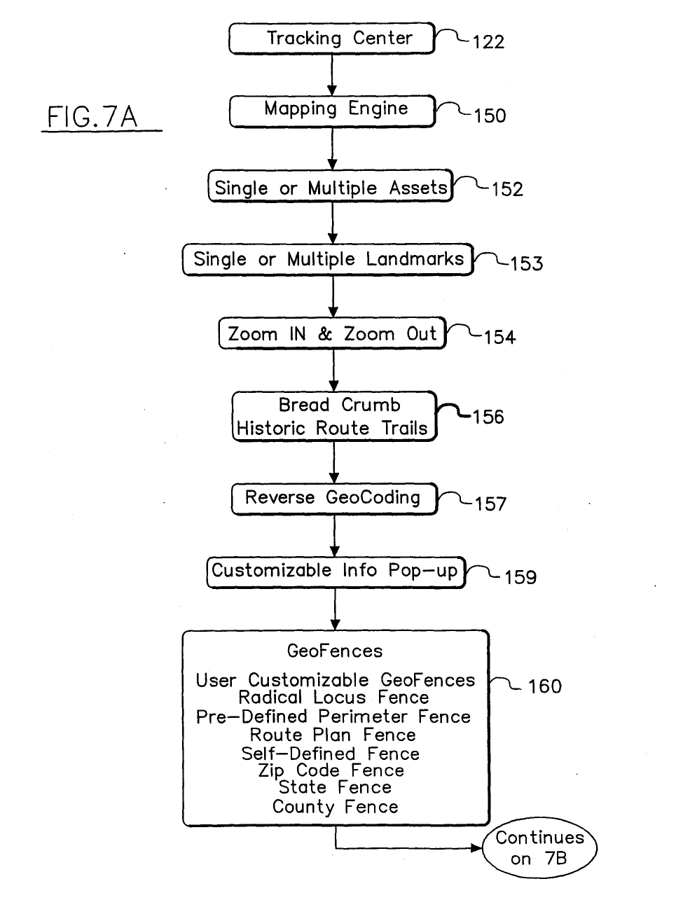

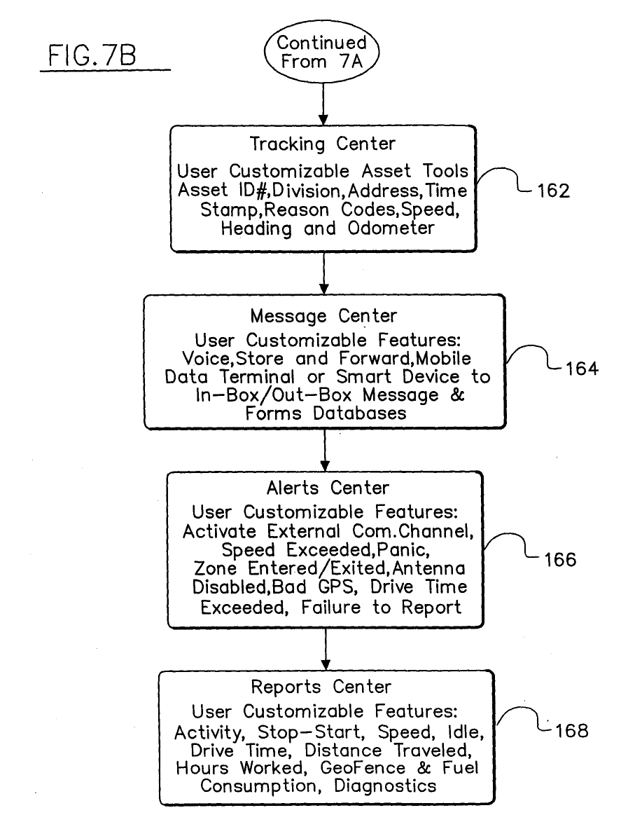

Tracking comm center 10 employs various functional module or methodologies which modules are generally identified in FIG. 5. The command or communications center includes an administrative center module 120, a tracking center module 122, a mapping engine 124, a message center 126, and alert center 128, a report center 130, a back office function group 132, a report engine 134, a billing engine 136 and an inventory control engine 138. The user can access any one or more of these major functional modules by selection of an appropriate tab or item on the initial sign on display screen. Therefore, the sequential presentation of these modules in FIG. 5 is not accurate since the user can directly access tracking center 122 without passing through administrative center 120. Of course, the tracking comm center 10 and associated software includes various levels of password control and may include biometric sensing control and authentication prior to permitting any particular person access to the critical data. The sequential presentation in FIGS. 6A-8B is not important.

### Administrative Center

The ubiquitous tracking method and system is generally configured as a database or data structure. Therefore, the major functional modules shown in FIG. 1, admin center, tracking center, mapping engine, message center, alert center, report center and various back office operations are configured as a series modules. Output data display screens and report generation functions can be presented in a wide variety of ways. Tables are employed herein to identify the labels, data fields, tabs and functional screen elements (hot buttons) which are important to the operation of the commercial embodiment of the present invention. Certain functions are used with respect to certain inventive aspects of the present invention whereas others are not critical but are simply helpful in the smooth operation of the tracking comm center. The administrative center enables the user to configure and compile his or her particular customer profile. This involves assigning companies function 130, assign groups within the company and types of assets within the companies in function 131, assign people to tracking devices in function 133, assign assets to tracking devices in function 134, assign land marks unique to the customer (trucking depots, major company offices, major customer depots, etc.), in function 136, assign tracking devices in function 137, assign administrator and user security levels in function 138, and assign user security controls and administration permissions in function 139. The profile and data per functions 130-137 can be added, viewed and edited. Continuing on FIG. 6B, the customer can also determine the number of display screen employed in function 140, can switch between company division groups or single tracked asset in function 142, switch between time zones and languages in function 144, and engage help screens in function 146. Details of various critical functions are discussed hereinafter. The following Administration Division Table shows how company groups in functions 130, 131 are assigned to other accounts and tracking id or tracking device identification numbers.

ADMIN DIVISION TABLE

| | | |
|---|---|---|
| Main Menu Bar | English | EST Time (Sel. Time Zone) |

| | |
|---|---|
| Search (Sch) Term Input | Select (Sel.) Division |

Data Table:

| ID | Company/name | Account | Credits | Enroll | Bio-ID |
|---|---|---|---|---|---|
| 500 | ESI Positioning | ESxxx | 5 | Enroll | filed |
| 5063 | Service Exp | EBRxx | 5 | Enroll | not filed |

On many of the display screens, the user is presented with a main menu bar or table which shows a number of tabs which, when activated by the user, shift the display from the current display to the targeted display associated with that tab. Therefore, when the user is viewing administration-division display screen in functions 130, 131, by activating the “mobile people” tab shown in the Main Menu Table below, the user is shifted to the display for assign people function 133.

MAIN MENU TABLE

| | |
|---|---|
| Mobile Assets | Sel: English |
| Mobile People | Spanish |
| Landmarks | Portuguese |
| Mobile Devices | Sel: Time Zone |
| Drivers | EST |
| Administration | CST |
| Divisions | MST |
| Administrators | PST |
| Notifications | |

In addition, the display module has the following Icon and Function Tab Table.

ICON AND FUNCTION TAB TABLE
Header - Can be Skinned by Reseller or Corporate Customer, and reseller or customer can
complete with custom colors, graphics and logo
Home Link - takes user back to Tracking Center main view
Logout - Enables user to log-out of the Command Center
Help - Provides insightful information to assist user
World Time - Brings up a World Map with Global City Listings, then shows time in
selected City
Language Drop-Down - Enables user to choose between English, Spanish and Portuguese
Time Zone Drop-Down - Enables viewed times to be shown in any selected time-zone
Current Date and Time for Selected Time Zone
Alert Center Button - Switches user to page which displays any existing alert conditions,
such as “Geofence Exited” and “Speed Exceeded” and other exceptions
Tracking Center Button - switches user to the Tracking Center
Asset Selection Button - user may choose to go to the Live Maps Asset Selection,
Breadcrumb Trail Asset Selection or Landmark Selection page
Geofence Button - Enables user to add, view or edit a Geofence
Message Button - Enables Command Center user to compose, send and respond to
messages on mobile devices
View Reports Button - takes user to Report Center page
Command Center Button - enables Administrator to customize the Command Center for
their use
Enables direct entry of Asset ID to locate the status of a specific device or mobile unit
Asset Group Drop-Down helps to select multiple units to narrow or widen the scope of
reporting information from multiple mobile units or devices that have been grouped
together
Division Drop Down helps to select multiple units to narrow or widen the scope of
reporting information from an entire division of mobile units or devices
Items Drop-Down enables user to select how many mobile units or devices are displayed in
the browser page at one time
Asset ID Sort - enables the user to sort the list of data by the Asset ID
Time Stamp Sort - clicking on the underlined text enables the user to sort the list of data by
the Time and Date of the last event
Reason Code - clicking on the underlined text enables the user to sort the list of data by the
Reason Code of the last incoming report
Speed Sort - clicking on the underlined text enables the user to sort the list of data by the
last listed event
Heading Sort - clicking on the underlined text enables the user to sort the list of data by the
direction of travel

With respect to the Division Selection function which is a drop down menu on a display screen, the system can be configured by the user to show the primary corporate name and various divisions under the corporate name. Therefore, in the following Division Table, Stealth Trak is the primary company with groups Angel, Global Search, Orbcomm. Within Global is a sub-division KFC-able. Further, under the Orbcomm division are sub-divisions Amerixxx and a sub-subdivision Paulxxx. In this manner, the display screen can be configured for a specific reseller to show only his or her accounts. In other words, the reseller could place his or her own banner at the top of the screen (see header skin feature above) and list the reseller's name as the primary provider (see table-Stealth Trak) and various companies supported by that reseller such as companies Angel, Global Search and Orbcomm. If a manager from Orbcomm accessed the tracking method and system in comm center 10, the Orbcomm manager would see under the “Select Division” the Orbcomm name as the primary name and list sub-divisions Amerixxx and sub-subdivision Paulxxx. Other divisions are not viewable since the manager does not have permission to view other data or divisions. As a further enhancement, if Paulxxx accessed the tracking comm center, he would only be permitted to see the tracking information for Paulxxx.

DIVISION TABLE
Stealth Trak
* Angel
* Global Search
** KFC - able
* Orbcomm
** Ameri xxx
*** Paul xxx

Assign People links drivers and managers and sales people (if necessary) to tracking modem ids, vehicles, trucks or other assets. Assign Asset function 134 assigns further assets or groups of trackable assets to a single cohesive unit. Functions 1-7 assign devices and also assign particular tracking devices to a singular asset and that asset to a group of tracked assets. For example, with respect to FIG. 2, all of the sensors 51, 53, 54, 56, 57, 59 and MTD 61 would be associated with tracking modem 64. The sensors would have their own ids which would be relayed or processed by tracking modem 64. In any event, all the sensors should be logged into the tracking comm center 10 and associated with the driver in tractor 52.

The following Admin-Divisions-Menus List provides more data for these data input and configuration screens.

Administration - Divisions - Menus - Hot Button and Icon Actuator List

| | |
|---|---|
| Home Link | takes user back to Tracking Center main view |
| Logout | Enables user to log-out of the Command Center |
| Help | Provides insightful information to assist user |
| World Time | Brings up a World Map with Global City Listings, then shows time |
| | in selected City |
| Language Drop-Down | Enables user to choose between English, Spanish and Portuguese |
| Time Zone Drop-Down | Enables viewed times to be shown in any selected time-zone |
| Mobile Assets Button | Enables mobile asset details to be configured so that it will be |
| | displayed properly in maps, records and data files |
| Mobile People Button | Enables mobile individual's details to be configured so that it the |
| | person will be displayed properly in maps, records and data files |
| Landmarks Button | Enables the custom configuration of individual Landmarks with a |
| | specified Name, Icon, Type, Address, City, State, Zip and Division |
| | so that the landmark and its associated data will be properly reflected |
| | in maps, records and data files |
| Mobile Devices Button | Enables mobile device details to be configured so that it will be |
| | displayed properly in maps, records and data files |
| Administration Button | Enables the Administrator to configure accounts and enroll them with |
| | Biometric Identity data |
| Drivers Button | Enables the configuration of driver specific information, for |
| | situations where it is necessary to track an individual driver who may |
| | drive multiple vehicles, including the Biometric Identity of the driver |
| Divisions Button | Enables viewing/editing of mobile devices by their Division |
| Administrators | Enables enrollment of individuals who can act as the Administrator |
| | to configure and edit the tracking of their own mobile devices |
| Notifications Button | displays known problems and alerts users to pending maintenance |
| Search Window Button | Opens a new window with options for searching for a specific mobile |
| | asset |
| Select Division Drop Down | Enables user to view and configure mobile assets within a specific |
| | division |
| Update Button | displays the Search dialog, allowing the user to search the data source |
| | connected to the grid. |
| Edit Record Button | Displays the Edit dialog to edit the highlighted record |
| Add Record Button | Displays the Edit dialog to add a new record to the database |
| Delete Button | Deletes the currently selected record |
| Number or Arrow | Displays the first page of the grid |
| Number or Arrow | Displays the previous page of the grid |
| Number or Arrow | Displays the next page of the grid |
| Number or Arrow | Displays the number of pages selected |
| Number or Arrow | Displays the next page of the grid |
| Final Page Button | Displays the last page of the grid |
| Rows | Shows the number of rows selected |
| Save Button | Enables the grid shown on the page to be saved in HTML, Word or |
| | Excel format |
| Format Button | Sets the format that will be used when clicking on the Save Button |
| | (31) |
| Print Grid Button | Prints all pages of shown data in a Grid format |
| Copy Grid Button | copies the shown data to the clipboard so that it can be pasted into |
| | other documents and files |
| Specify Sort Button | Allows the user to configure nested sorts of data within the grid |
| Help Button | displays a help page to provide the user with further information |
| Device ID Button | Enables the Display and sorting of each of the mobile devices by |
| | their ID number |
| CompanyName | Enables the Display and sorting of each of the mobile devices by |
| | their Company Name |
| Account | Enables the Display and sorting of each of the mobile devices by |
| | their Account Name |
| Credits | Enables the Display and sorting of each of the mobile devices by the |
| | number of available credits |
| Enroll | Enables enrollment (entry) of additional devices into a specific |
| | division |
| Bio-ID | Enables the Display and sorting of each of the mobile devices by |
| | their Bio-ID |
| Enroll | Opens window to enter Biometric data for future authentication |

The following Administrator Center and Mobile Devices Table shows this type of identification.

Admin Center - Mobile Devices

| Main Menu Tabs | | English (Sel. Lang.) | EST (sel. Time zone) |
|---|---|---|---|
| | Sel. Asset | Search Asset/Term | Sel. Division |

Devices - Admin Center
Data Table:

| | Assigned to | | | | | | |
|---|---|---|---|---|---|---|---|
| Device ID | Asset | Serial # | Status | Model | Sim | Period | Division |
| CoolZ-04 | TK-11 | 2218 | deact/invt | STEZ | −13 84 | 15 | CoolZ |
| CoolZ-05 | TK-14 | 2218 | deact/invt | STEZ | −14 44 | 15 | CoolZ |

The Mobile Devices Table shows, in addition to the main menu tabs and language selection tabs and time zone selection tabs (discussed later), a device id. The device id may be the shorthand description assigned to the trackable asset by the customer. The serial number is the serial number of the tracking modem (or tracking device), the status indicates whether the modem is activated or deactivated and whether it is in inventory (invt), the model is the type of manufacturer, the SIM is the sim code for the GSM cell phone, period is an indicator of recording periods and division is the organizational division within the company.

The following Hot Button and Icon Actuator Table shows additional features for thepresent invention.

Admin - Mobile Devices - - Hot Button and Icon Actuator List and Data Column Explanation

| | |
|---|---|
| Home Link | takes user back to Tracking Center main view |
| Logout | Enables user to log-out of the Command Center |
| Help | Provides insightful information to assist user |
| World Time | Brings up a World Map with Global City Listings, then shows time |
| | in selected City |
| Language Drop-Down | Enables user to choose between English, Spanish and Portuguese |
| Time Zone Drop-Down | Enables viewed times to be shown in any selected time-zone |
| Mobile Assets Button | Enables mobile asset details to be configured so that it will be |
| | displayed properly in maps, records and data files |
| Mobile People Button | Enables mobile individual's details to be configured so that it the |
| | person will be displayed properly in maps, records and data files |
| Landmarks Button | Enables the custom configuration of individual Landmarks with a |
| | specified Name, Icon, Type, Address, City, State, Zip and Division so |
| | that the landmark and its associated data will be properly reflected in |
| | maps, records and data files |
| Mobile Devices Button | Enables mobile device details to be configured so that it will be |
| | displayed properly in maps, records and data files |
| Administration Button | Enables the Administrator to configure accounts and enroll them with |
| | Biometric Identity data |
| Drivers Button | Enables the configuration of driver specific information, for |
| | situations where it is necessary to track an individual driver who may |
| | drive multiple vehicles, including the Biometric Identity of the driver |
| View/Edit Devices Button | Enables further configuration of mobile devices to specify a Device |
| | ID, Asset Assignment, Serial Number, Status of the Mobile Device, |
| | Device Model, Internal SIM Chip Number, Period and Division |
| Devices Approve Button | 2^{nd} step when editing devices, enabling the devices to be saved into |
| | the database |
| Search | Enables the user to find a mobile asset based on a typed-in query |
| Select Division Drop Down | Enables user to configure mobile assets within a specific division |
| Search Window Button | Opens a new window with options for searching for a specific mobile |
| | asset |
| Update Button | updates the selected mobile asset throughout the system |
| Add Record Button | Creates a new mobile asset record so it can be configured |
| Delete Record Button | Allows user to delete a mobile asset from the database |
| 1^{st} Page Button | Goes to the First of Multiple Pages |
| Arrow | Back One Page Button |
| Arrow | Page Drop Down Button |
| Number | Number of Pages Indicator |
| Advance One Page Button | Displays next page of records |
| Final Page Button | Advances pages forward to the last page of records |
| Rows | Shows the number of rows on a page |
| Save Button | Enables the grid shown on the page to be saved in HTML, Word or |
| | Excel format |
| Format Button | Sets the format that will be used when clicking on the Save Button |
| | (31) |
| Print Grid Button | Prints all pages of shown data in a Grid format |
| Copy Grid Button | copies the shown data to the clipboard so that it can be pasted into |
| | other documents and files |
| Specify Sort Button | Allows the user to configure how the page is sorted with the option for |
| | customizing the sort for their own preferences |
| Help Button | displays a help page to provide the user with further information |
| Device ID Button | Displays each of the mobile devices, and can be sorted by Device ID |
| Assigned to Asset | enables the user to specify the Asset to which the device is assigned |
| Serial # | enables the user to specify the Asset serial number of the mobile |
| | device |
| Status | shows the current status of the mobile device |
| Model | enables the user to further identify characteristics of the mobile asset, |
| | such as a Tag |
| Sim | Displays the associated SIM Chip information associated with the |
| | mobile device |
| Period | Displays the period of the mobile device |
| Division | Shows the Division that is used to identify multiple mobile assets |
| | together |

Admin Center - Mobile Assets Table

| | | |
|---|---|---|
| | English (sel. Lang.) | EST (sel. Time zone) |
| Main Menu | Sch Term | Sel Div. |

Data Table Part I:

| | | | | |
|---|---|---|---|---|
| (1) Asset Unique I.D. | Icon Asset | Type | Make | Model |
| (2) #24 Franzs Truck | | Ford 350 | Ford | 350 Tag #U066JI |

Data Table Part II:

| | | | |
|---|---|---|---|
| (1) Year | Assigned Device | Division | GeoFence# |
| (2) 06 | AB-9 | American_Battery | 32 |

The Administrative Center-Mobile Assets Table enables the customer to assign asset unique id, an icon associated with that particular asset, the type of trackable asset such as a Ford pickup or a Ford utility van or other types of truck or trailer designation, the make is “Ford” or the manufacturer of the tractor and/or trailer, the model can be configured as the tag number, the year indicates model year of the vehicle, the assigned device is another unique identifier associated with the asset, division is the organizational division within the organization and the geo fence indicates whether the asset being tracked is subject to a geo fence. The geographic fencing function is discussed later. The Mobile Assets Table shown below is broken into two parts and is generally in a landscape mode. Rows 1 and 2 are laterally aligned on the page in the landscape format.

The following Mobile Asset Label Table provides more information.

Admin - Mobile Asset Column Data Label Table

| | |
|---|---|
| Asset | shows the name that will be used throughout the database in |
| Unique ID | association with a specific asset |
| Icon | shows the icon that will be graphically displayed on maps in |
| | association with the mobile asset |
| Type | enables the user to specify the mobile asset model |
| Make | enables the user to specify the make of the vehicle |
| Model | enables the user to further identify characteristics of the |
| | mobile asset, such as a Tag Number |
| Year | enables the user to identify the year of the associated vehicle |
| Assigned | identifies the specific device assigned to the mobile asset |
| Device | |
| Division | Shows the Division that is used to identify multiple mobile |
| | assets together |
| GeoFence | Opens a page showing a map that can be used to view, edit |
| | or create a GeoFence for the associated asset |

In FIG. 6A, assigned function 136 is discussed later in conjunction with the mapping engine. The number of display landmark screens function 140, switching time zone function 144 and switching language function 144 is discussed later in conjunction with the Tracking Center Table.

### Tracking Center

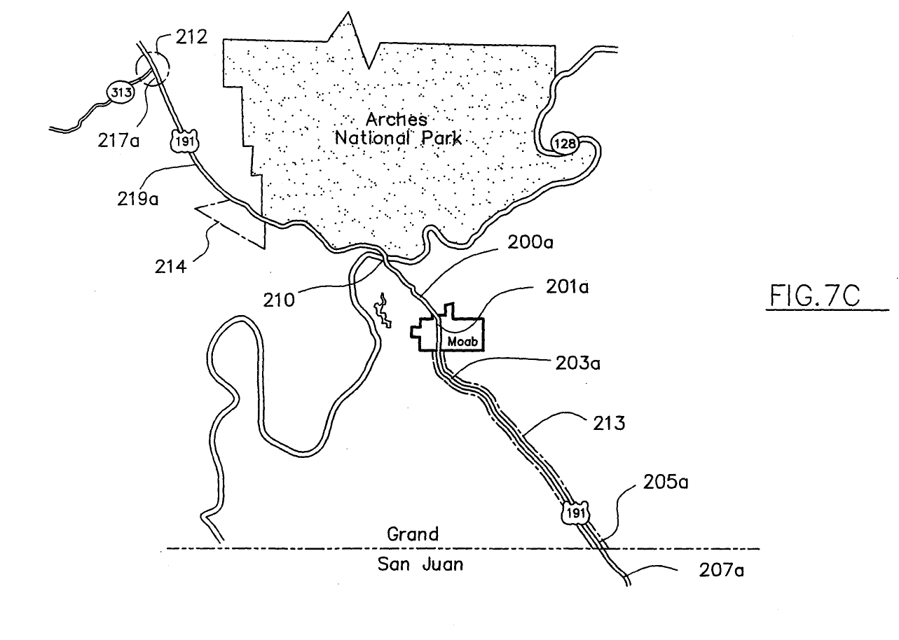

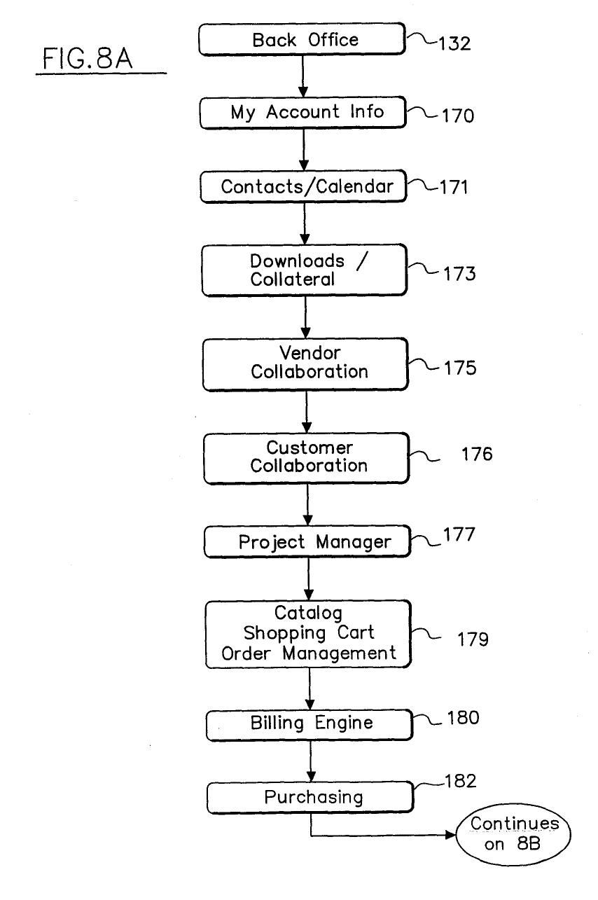

FIGS. 7A and 7B generally show major aspects of the Tracking Center. These major aspects of Tracking Center function 122 include a mapping function, a display correlating the historic path of the tracking device on the map, a user definable geo fence or geographic limitation imposed electronically on a map with respect to a tracking device, and message center noting messages to the tracking device and messages from the tracking device, and Alert center and a Report center. As indicated earlier, the user can access these functions one at a time or concurrently, Sequential operation is not necessary. Multiple functions can be concurrently activated on different browsers in the ASP web-based system so the user may place a historic route trail on a map for a certain device or truck or tracking item on one screen and show alert history for the same tracking device on another screen concurrently. The tracking center 122 includes mapping engine function 150, enabling single or multiple assets to be tracked on a user selectable map in function 152 and permitting the user to identify single or multiple land marks on the map in function 153. Landmarks are added to maps by the users or the landmarks are part of commercially available computer display maps. Function 153 permits the user to add landmarks. Function 154 enables the user to zoom in or zoom out of a displayed map. Function 156 is a historical route trail of a certain track device. Sometimes this is called a bread crumb trail. Function 157 is reverse-geo coding function showing either the longitude and latitude of the tracking device or alternatively the street address or the highway route number for the located tracking device. Function 159 enables the user, when viewing a displayable map, to customize the pop up informational window when the user's cursor is over the icon selected for that tracked item. Maps and records are stored in the tracking record database.

FIG. 7C illustrates a map showing several features including map shifting and geo-fence monitoring.

In the Mobile Assets Table identified above, the “icon” for the asset is a unique icon associated with a tracking id that can show a mini van, a pickup truck, a passenger car, a tractor, a tractor-trailer combination, a tanker truck or any other user selectable icon all with user selectable colors. Therefore, the icon shown in the Mobile Assets Table is the icon shown on the displayable map. When the user places his or her cursor on the icon overlaid on a displayed map, a window pops up showing the specific location information which specific information is user selectable. One type of pop-up window default would be the latitude and longitude of the tracked item. Another type of default would be the street address, driver name and shipping customer name.

Geo fence function 160 is discussed later herein. Tracking Center 162, Message Center 164, Alert Center 166 and Report Center 168 are also separately discussed below.

The Tracking Center Table below provides a general indication of the information on this user configurable display.

TRACKING CENTER TABLE

| | | |
|---|---|---|
| Main Menu | English (Sel. Lang.) | EST (Sel. Time Zone0 |

| | | |
|---|---|---|
| Sch by Asset | Sel Group | Sel Division |

Data Table Part I:

| | | | | | | |
|---|---|---|---|---|---|---|
| Asset Tool | Asset ID | Driver | Division | Address | Time Stamp | Event |
| (1) F1, F2 | Dalbo 132 | Joe | Dalbo | 13122 Cr-24 | 11/15/2006 | en route |
| | | | | Meeker Co 81641 | 4:58:00 PM | |

Data Table Part II:

| Speed | Direction |
|---|---|
| (1) 15 | NW |

The following Hot Button List provides additional data for these screens.

Tracking Center Icons and Hot Button List

| | |
|---|---|
| Alert Center Button | Switches user to page which displays any |
| | existing alert conditions, such as “Geofence |
| | Exited” and “Speed Exceeded” and other |
| | exceptions |
| Tracking | switches user to the Tracking Center |
| Center Button | |
| Asset | user may choose to go to the Live Maps Asset |
| Selection Button | Selection, Breadcrumb |
| | Trail Asset Selection or Landmark Selection page |
| Geofence Button | Enables user to add, view or edit a Geofence |
| Message Button | Enables Command Center user to compose, |
| | send and respond to messages on mobile devices |
| Message Button | Enables Command Center user to compose, |
| | send and respond to messages on mobile devices |
| View Reports Button | takes user to Report Center page |
| Command | enables Administrator to customize the Command |
| Center Button | Center for their use |
| Search Asset id | Enables direct entry of Asset ID to locate |
| | the status of a specific device or mobile unit |

The Asset Tool function is provided in an effort to enable the user to quickly go to various other reports and action screens for a particular tracked asset. This tool is discussed later. The asset id is the identifier assigned to the tracking device by the user. This asset id may or may not be the tracking device id but is correlated with or associated with the tracking device id in the tracking database 108 discussed earlier. The driver column identifies the driver for the tracking device. Division is the organizational division controlling or associating with the driver and the tracking device. The address is the current location of the tracking device. The time stamp is the date and time established locally by the operator and setable by the operator, that is, the time zone is setable by the operator. The event field indicates the current event associated with the tracking device and where it is going. The direction and speed is also shown.

### Multiple Language Selector

The present invention enables the user to select the language that is displayed in any particular display screen or formatted data output. The user selects a language with a language selector on the user's client application which selection is accepted by the tracking comm server. In order to accomplish this, the tracking comm center 10 includes either a data translation profiles for commonly used terms and phrases or a phraseology dictionary lookup table for commonly used phrases in a particular industry. Some words in the display such as the driver's name and sometimes the street name do not change. At other times, the city name or country may change base upon the selected language. This is beneficial because, in some instances, the driver communicates better in his native language which is not English and the system user may be a route manager which speaks the same language as the driver. In this situation, it is helpful for the route manager to be able to see the display screen in English such that the route manager may communicate with other managers in his or her operation and, at the same time, the route manager can see the same formatted screen display in a different language, not English by deploying a different browser and selecting a second language. Communicating the same data in two or more languages is a significant feature. Therefore, the tracking system compiles the data structure in at least two languages. The compilation of output display screens occurs on the fly per user command. Data subject to language conversion includes among other items, the geographic description data for the locus data, event description data for the event code, message data, and various associated tracking device data such as asset data associated with the tracking device, driver data associated with the tracking device, asset load condition data, speed data, direction data, event code data received from the tracking device, messages received from the tracking device, messages sent to the tracking device, and the party owning or controlling the tracking device or tracked asset. The operator can present a first language on a first monitor via the output display generator and the organized data display typically includes tracking device id (or representation thereof), geographic location, event description as an event code or message data and an event time. Further, associated tracking data is shown in the first language such as driver data, asset mode condition data, speed, direction, messages received, messages sent and party owner-controller. Upon a further selection by the operator, the same information is presented in a second language in the same organizational display or format as the first language. In addition, the labels on the display for each column or data field change to conform to the language selected by the user (English, Spanish, Portuguese, etc.). Therefore, in the Tracking Center Table, the labels asset tool, asset id, driver, division, address, time stamp, event, speed, direction would be changed from English into Spanish based upon the language selection by the user. Implementing the present invention in an ASP model enables the tracker server 115 to display the same screen with the same information in two different languages at the same time. Further, these computer screens need not be at the same location but may be geographically separated. Therefore, in a highly diverse organization, with multiple language skills for various members of management, information is conveyed in real time and a number of languages can be used effectively and efficiently throughout the entire enterprise.

### Time Zone Selector

The Tracking Center Table also includes a time zone selector operable by the user. The zone selector is provided by the tracking server and the user's slection i snoted on the client application in the ASP modeled invention. Language selectors and time zone selectors are available on the display for the Administration Division Table, the Administrative Center-Mobile Devices Table, the Administrative Center-Mobile Assets Table, Tracking Center Table, Message Center Table, Alert Center Table and Report Center Table. With respect to the time zone selector, the user can set the initial time zone for the display. Typically, the tracking devices generate locus data, tracking id data and a time stamp. The time stamp includes the date and the time, typically in Greenwich Mean Time or GMT. In the present application GMT time is equivalent to a common time format. However, any “common time format” may be employed dependent upon the time stamp (which includes date) from the tracking device. In any event, the time stamp is sent with the tracking device id and the locus data that is eventually collected by the tracking comm center 10. Addressee data locates comm center 108. This data packet or information is stored in an appropriate record in the tracking database 108.

In general, it is difficult for the management of the track device to accurately identify the correct time and communicate time based instructions to employees, managers, customers, drivers, etc., if all time displays are shown in GMT time. Therefore, prior art systems have converted to GMT time into a local time for a particular enterprise having a number of tracking devices. However, a problem arises in that if the organization has tracking assets which span several time zones, confusion often arises when messages are sent and/or received without the accurate indication of the “local time” where the tracking device currently resides.

The implementation of a user selectable time zone greatly enhances communications between the user's control (displaying the tracking comm center outputs) center and the drivers or persons interested in handling that tracked asset. Further, messages are oftentimes sent by the tracked device and messages are sent to the tracked device by the comm center 10. If mobile data terminals MDTs are utilized with the tracked vehicle, the MDT can announce to the driver or passenger certain important information. These are outbound messages from the comm center 10. Further, some MDTs include microphone whereby the driver can communicate and leave message to the driver's organization via comm center 10. These are messages from the tracked asset. These messages are time coded and time stamped initially by GMT time and then subsequently converted into the selected time zone. Biometric data is formatted as a message.

Therefore, the user configures the display for the Tracking Center Table (and other tables discussed herein) and selects the time which is either the local time for the user's control central 12 (FIG. 1) or the driver's “local time”. This conversion involves a time converter in comm center 10 which translates all logged time in database 108 from GMT (common time format) into the display time zone selected by the user. Therefore, the system converts upon time selector a display command, the event time data from the common time format into event time data in a local time format. It also converts respective time stamp data into the local time format. The output display generator function in the tracking comm ASP model generates a display for the user-client. The respective stamp data is associated with asset data and the tracking device, driver data associated with the tracking device, asset load condition data with or without the respective time stamp data, speed data for the tracking device with or without the respective time stamp data, direction data for the tracking device with and without the respective time stamp data, event code data received from the tracking device with and without the respective time stamp data, messages received data from the tracking data with and without the respective time stamp data, messages sent data through the tracking device with and without the respective time stamp data and party owning and controlling the data. Since the present tracking system is ubiquitous, some tracking devices are “dumb” and do not send messages but simply send “event code”. Other tracking devices are very sophisticated and send and receive messages, biometric signals, signature capture data obtained by writing tablets configured as part of the MDT, etc. Further, the tracking control system can also employ communications links to the driver's cell phone. If the cell phone is a GSM enabled, the tracking comm center 10 can track that cell phone and the GSM locator with that driver. Of course, the customer employing tracking comm center 10 may locate the driver's cell phone via a GSM and then directly call the driver utilizing cell phone telecommunications routes. Therefore, with respect to the time zone selector, some of the data collected from the tracking device and some of the data sent to the tracking device sometimes has time stamp data and at other times does not, dependent upon the device and the element being tracked. If the device or event being tracked has a time stamp on it, the system converts that time stamp from a common time format into a local time format as well as to any selected time zone format. In addition to the foregoing, the operator can open several browsers at the same time showing the same data structure and data organization except the first browser may show one time zone and the second browser may show the other time zone. This greatly increases the ability of the customer-operator to communicate with the person associated with the tracked asset. Asset Tool Bar

The Tracking Center Table includes an asset tool bar for each tracker record displayed and generally identified by an asset id. As discussed above, each record display generally includes an asset id, a driver, a division associated with the asset, an address of the tracking device, a time stamp (date), an event, speed, direction, etc. The asset tool is a plurality of action and report selection tools which can be selected for any particular “asset id” that is, a tracking device displayed on that display. The following Asset Tool Table provides examples:

ASSET TOOL TABLE

| Label Type | Function |
|---|---|
| Ping (F1) | generates a signal to the tracked target and requests |
| | a response |
| Map (F2) | shifts display screen to map for asset |
| Report (F3) | 12 or 24 hour report |
| 12 hr. Trail (F4) | display map and show 12 hour tracked location |
| Msg (message) (F5) | lists all messages associated with tracked target |
| Fence (F6) | show geo fence |

The asset tools available for each asset include an action polling or ping function which sends a signal to the tracking device and initiates a responsive signal from the tracking device. The display report function F3 includes displaying a historic report of all records for the tracking device. Function F4 displays a historic route (12 hr. trail) and posts the tracking device location on a displayed map. Function F2 displays a current location of the tracking device on a map. Function F6 displays a current location for the tracking device on a map with the geo fence for that tracked asset. The historic report is the historic report associated with the tracking device and is generally a table. Therefore, the asset tool shown in the Tool Table above includes six functions F1-F6 that are actuatable hot buttons on the display. By selecting the ping button, a polling signal is sent from the comm center 10 to the tracking device. By selecting the map F2 function, a map is displayed to the user and the current location of the tracking device is shown on that map. When the user places his or her cursor on the icon for the tracking device, a pop-up window appears on this map. The report hot button F3 displays a historic report of the tracking device and lists all the recorded reports for that tracking device over a predetermined period. The “12 hour trail” function button F4 is sometimes called a bread crumb trail. Actuation of this function F4 brings up a map showing the current location of the tracking device and the historic root of the tracking device for a predetermined period of time. In the current embodiment, a 12 hour period is provided but this predetermined or selected time period may be changed by the operator. The MSG or message function F5 generates a screen which shows all messages sent to the tracked target or tracking device and all messages from the tracking device. By selecting the fence F6 function, the current location of the tracking device is superimposed on a map and further any predetermined geographic limits or geo fence associated with the tracking device is also superimposed on the map.

### Map Function

The present invention can be configured to employ of various commercially available maps and maps supplied by users and owners of the tracking devices and tracked assets. These maps are synchronized with longitudinal and latitudinal or locus geographic points. A simple map is shown in FIG. 7C. In general, the Hierarchical Map Detail Table below shows a general example of an organized set of maps. Any organizational set may be used including orthogonal classifications. An example of orthogonal classification is a map of one county associated with a juxtaposed county map.

HIERARCHICAL MAP DETAIL TABLE
World
Continent
Country (countries)
U.S.
Regional
State
County (counties)
Zip Code
Street
Site or Yard (longitude/latitude w/in or w/out fence)
Building
Floor plan
Elevational Building plan

At the initial set-up, the user specifies what level the user wants to initially view the map when he or she identifies an asset to be displayed in conjunction with the map. Maps are stored in the data structure of the tracking database. International freight cargo may show the world or continent. Local regional residential movers may show a region in the U.S. or a state or county. Local delivery service companies may initially enter the map hierarchical list first by county and then by city or street.

One interesting feature of the present invention is the implementation of sites or yard maps that are provided to tracking comm center 10 by the user. Further, building maps, floor plans and elevational plans may also be integrated into the comm center.

### Map Sequencing Module

Another interesting feature of the present invention is the ability of the tracking method and system to shift from one map to another map when a tracking device transits or crosses a map boundary. Although a hierarchical map table is presented above, this classification simply is an organizational technique. Any organized classification system ay be employed. A tracking device, having a locus within a lower level map coordinate set, when that tracking device crosses the geographic data defined boundary for that lower level map, the display system and tracking method automatically changes the display map from the lower hierarchical level to the higher hierarchical map level. The system's output display generator module is activated. In a similar manner, when the tracking device passes a geographic data defined boundary and enters a lower level map area from a higher level map area, the system shifts from the displayed higher level map to the next lower level map. Further, another valuable feature of the present invention is the utilization of a site or yard map. A site or yard map may be simply a parking lot for trucks or may be a port within which is located numerous tracked items, containers, trucks, fork lifts, special objects designed to remain within the defined site or yard and object which should be in the site or yard only for a short period of time or taken out of the site or yard for no more than a predetermined period of time. The shipping port may have piers displayed on the map. Further, the site or yard map may be configured as a block or geographic region around a school for a sexual predator tracking system. A radial space polygon or other closed geometric shape may be used.

Therefore, public or private maps are obtained by the tracking center and the customer may supply additional specialized maps. For example, specified maps showing oil fields in generally non-documented rural spaces are important to oil companies and groups seeking to track mobile assets within that non-mapped rural area. Therefore the tracking method and system compiles a series of displayable maps which are displayable on the monitor. The series is generally hierarchically classified (or otherwise organized) into, for example, region, state, city geographic data defined boundaries, and further is classified with a site or yard map or maps with certain geographic data defined boundaries. The system determines when the geographic tracking data for the tracking device transits or passes from one hierarchically classified map into a lower hierarchically classified map based upon a transition of two obtained tracking data for the tracking device which cross a respective geographic data defined boundary for the lower hierarchically classified map. In FIG. 7C, a transit from point 200a to 201a causes the regional map 7C to change to a city map of Moab, Utah. The system then automatically triggers the display on the monitor from one hierarchically classified map to the lower hierarchically map while displaying the last obtained geographic tracking data. See transit from point 201a to 200a. Additionally or optionally, the system would automatically change from a lower hierarchically classified map into a broader or larger scope hierarchically classified map when the tracking device transits and exits the lower map boundary to the higher map. See transit from 201a to 203a. Of course, the term “hierarchically” may take into account maps classified at the same level (orthogonal) such as a map of one county which may by adjacent a map of another county. See transit from 205a to 207a. When a truck transits one county's boundaries and goes into the second county's boundaries, the transition occurs and the second county represents either the higher or lower hierarchically classified map. In a similar sense, when the tracked asset transits into the site or yard, a site specific or yard specific map is displayed to the user. See FIG. 1, site 41.

As a further enhancement, the series of displayable maps may include a building structural map, a floor plan structural map, a building elevational structural map. See FIG. 1. The building elevational structural map is the elevation of plan of the building above the ground. See L1 to L5. With the combination of the floor plan and the elevational map, the system may provide a three-dimensional illustration of the building and track a tracking device fixed in the building or moving in the building. From a data processing point of view, when the tracking device transits the site or yard map into the structural map (represented by the building, floor plan or elevational map), the display system automatically changes to display the structural map. The reverse map shifting process is also provided for.

This map shifting function can also be applied to vessels in lakes, rivers and on oceans and seas such that when the cargo ship or tracked vessel approaches a port, more detailed maps are displayed to the user/viewer. When the cargo ship off loads a container with the tracking device, the display map may shift to the pier and dock which is physically near the tracked container. As the container is moved through storage facilities (buildings) or outside storage locations in the yard, the system tracks these locations. When the cargo is loaded on a tractor trailer, and moved beyond the port (site or yard), the map extends to the next higher hierarchical level. See FIG. 1.

### Geographic Alert System

Another interesting feature of the present invention is the implementation of the geo fence or geographic alarm system based upon a user definable geographic limits. As discussed above, the user either purchases or organizes a series of displayable maps which are classified in some organized manner either hierarchically or orthogonally, or both. Land marks may be part entrances. See point 210 in FIG. 7C. Further, site or yard maps are part of the classified system. See site 41, FIG. 1. In addition, the user inputs user-definable geographic limits represented by programmable geographic data defined boundaries. These user defined geographic limits have a substantially closed shape. The substantially closed shape includes, among others, a radial defined shape 212 from a single point (FIG. 7C), an oval fence shape from two defined points, a free form fenced shape wherein the user defines multiple points which are connected together, a route parallel track shape 213 wherein the user identifies a particular route or highway and the system automatically defines a geographic data defined boundary within so many feet or so many yards of that identified route, roadway or street, a connect-the-dots user defined fence shape and a polygon definable fence shape 214. With respect to the polygon definable fence shape 214, the user may select various shapes from a tool bar and apply them as he or she sees fit as geographic limits. With respect to the radial fence shape 212, the user selects the center point of the radius and then identifies the radial dimension of the radial fence. Once these user definable geographic limits are set, the system identifies data defined boundaries associated with those geographic limits. The system them monitors the tracking device based upon locus data from the tracking device. When the tracking device transits over the substantially closed shape of the user definable geographic limits based upon a transition between two obtained geographic tracking data from the tracking device which cross the closed shape (see transition from point 217a to 219a, FIG. 7C), the system automatically issues an alert message based upon the transit. The system's output generator issues an alert. The transit may be entering or exiting the defined geo fence or used defined boundary.

In addition to the user definable geographic limits or geo fence, the system includes a temporal tracker. The temporal tracker determines the time the tracked device enters the closed geometric shape (time t1 in shape 212) (or leaves the closed geometric shape) and automatically issues an alert message when the time inside or outside the geo fence exceeds predetermined time parameters (time t1 exceeds city limit temporal time tc). For example, a truck driver may be committed to stop his or her truck along a predefined route and the truck driver having a GSM activated cell phone may leave the geo fence territory, which is a certain defined distance on either side of the truck route. See route fence 213. If the truck driver leaves the geo fence territory for more than one hour, equivalent to lunch or dinner break, an alert may be sent by the tracking comm center to the driver's cell phone requesting that he or she return and continue driving the truck. A contrary system may require the driver to leave the truck for a nightly rest or sleep period of 8 hours. If the driver attempts to move the truck within the 8 hour rest period, the alert from the comm center 10 may be a vehicle disable signal to the tractor associated with the driver needing sleep. Of course, many other applications of this temporal limit combined with the geo fence can be established. Sex offenders, prisoner monitoring, shipment of cargo, handling of hazardous waste, and a wide variety of other tracked elements can be monitored by this geo fence and temporal limit. The enhanced communications channel functions involving polling or pinging, sending a message to the tracked device, receiving messages from the tracked device, further enhance the geo fence feature of the present invention.

As stated in function 160 of FIG. 7A, the geo fence is user customizable and may include a state code fence, a zip code fence or a country fence.

### Message Center-Alert Center-Report Center

In FIG. 7B, the functional blocks for message center 164, alert center 166 and report center 168 are provided. The Message Center Table set forth below provides some indication of messages sent to and from the tracked device and the driver or other operator or persons associated with that tracked device.

MESSAGE CENTER TABLE

| | |
|---|---|
| English (Sel. Lang.) | EST (Sel. Time Zone) |

| | | |
|---|---|---|
| Sch by Asset | Sel Asset Grp | Sel Division |

Data Table:

| | Message Type | AssetID | Time Stamp | Message | View Larger | Compose |
|---|---|---|---|---|---|---|
| in | Message Center | 1798 | Nov 12 2006 | Message: | View Larger | Reply |
| | | | 8:18 PM | | | |
| out | MSG | | Aug 24 2005 | Prueba | View Larger | |
| | | | 7:07 PM | 240805, | | |
| | | | | desde hidaladr | | |

In the Message Center Table, the user can select the language and the time zone as well as initiate a search through database 108 by tracking id, tracked asset, by organizational group or select a division of interest. All messages to and from the tracked device are reported in the Message Center. A short form message is shown in the message area and the operator or viewer can select a larger area. The system enables the operator to select, under the “compose” activity, a message to be sent to the tracked device. On the left side, the “in” and “out” indicates whether the driver or tracked item is currently in the system and en route or otherwise engaged or out of the system.

The following Hot Button Table shows additional tools to the user.

Message Center - Hot Button and Icon Actuator List

| | |
|---|---|
| Home Link | takes user back to Tracking Center main view |
| Logout | Enables user to log-out of the Command Center |
| Help | Provides insightful information to assist user |
| World Time | Brings up a World Map with Global City Listings, then shows time in |
| | selected City |
| Language Drop-Down | Enables user to choose between English, Spanish and Portuguese |
| Time Zone Drop-Down | Enables viewed times to be shown in any selected time-zone |
| Alert Center Button | Switches user to page which displays any existing alert conditions, |
| | such as “Geofence Exited” and “Speed Exceeded” and other |
| | exceptions |
| Tracking Center Button | switches user to the Tracking Center |
| Asset Selection Button | user may choose to go to the Live Maps Asset Selection, Breadcrumb |
| | Trail Asset Selection or Landmark Selection page |
| Trail Asset Selection or | user may choose to go to the Live Maps Asset Selection, Breadcrumb |
| Landmark Selection page | Trail Asset Selection or Landmark Selection page |
| Asset Selection Button | |
| Asset Selection Button | user may choose to go to the Live Maps Asset Selection, Breadcrumb |
| | Trail Asset Selection or Landmark Selection page |
| Geofence Button | Enables user to add, view or edit a Geofence |
| Message Button | Enables Command Center user to compose, send and respond to |
| | messages on mobile devices |
| View Reports Button | takes user to Report Center page |
| Command Center Button | enables Administrator to customize the Command Center for their use |

The Alert Center Table shows an example of a display screen output which is an organized display of all alerts associated with the asset identified or the group identified or the division identified.

ALERT CENTER TABLE

| | | | |
|---|---|---|---|
| | English | | |
| | (sel. lang.) | EST (sel. time zone) | |
| Main Menu Bar | Sch by Asset | Sel Asset Group | Sel Division |

Data Table:

| Map | Asset ID | Alert Type | Address | Time Stamp |
|---|---|---|---|---|
| Map (F) | BF 99 | Antenna | Blank | 11/15/2006 |
| | | Disconnected | | 5:07:00 PM |
| Map (F) | Steve Mc | Geo Fence | Ut-45 Vernal, | 11/15/2006 |
| | | Outside | Ut 84078 | 5:05:00 PM |
| Map (F) | BF 96 | Geo Fence | Road A. Norton, | 11/15/2006 |
| | | Exited | Ks 76754 | 4:58:00 PM |

On the left side, the operator can select the hot button “map” function F which automatically shifts the display to the user defined map within which is shown the tracked item, with an icon for the tracked item, and a map at the particular hierarchical level as previously selected by the user. The asset id is a short form identification assigned to that tracker device. The alert type is typically one of a number or predefined alerts that inform the customer of an external events. One of the external event functions available to the user is to initiate a call to a management person or an email or blackberry or electronic notification of a series of events needing his or her immediate attention. The address and time stamp represent the current location of the tracking device and the last recorded time stamp. The user can select one or more languages from the select language selection and may change the time zone displayed as discussed above. The Alert Center can be utilized to activate external communications channel when speed is exceeded, indicate a panic alarm, a geo-fence zone entered or exited alarm, and internal disable alarm, a bad GPS signal or signals, a drive time exceeded alarm and a failure to report alarm. See FIG. 7B.

The following Hot Button List provides more functions to the user.

Alert Center - Icon and Hot Button List

| | |
|---|---|
| Map | Opens Map showing position of vehicle or device |
| Alert Center Button | Switches user to page which displays any existing alert conditions, |
| | such as “Geofence Exited” and “Speed Exceeded” and other |
| | exceptions |
| Tracking Center Button | switches user to the Tracking Center |
| Asset Selection Button | user may choose to go to the Live Maps Asset Selection, Breadcrumb |
| | Trail Asset Selection or Landmark Selection page |
| Geofence Button | Enables user to add, view or edit a Geofence |
| Message Button | Enables Command Center user to compose, send and respond to |
| | messages on mobile devices |
| View Reports Button | takes user to Report Center page |
| Command Center Button | enables Administrator to customize the Command Center for their use |
| Search Asset id | Enables direct entry of Asset ID to locate the status of a specific |
| | device or mobile unit |
| Asset Group Drop-Down | helps to select multiple units to narrow or widen the scope of |
| | reporting information from multiple mobile units or devices that have |
| | been grouped together |
| Division Drop Down | helps to select multiple units to narrow or widen the scope of |
| | reporting information from an entire division of mobile units or |
| | devices |
| Items Drop-Down | enables user to select how many mobile units or devices are displayed |
| | in the browser page at one time |
| Selection Option | Enables Viewer to Dismiss the Alert Condition |

The following Report Center Table provides one indication of a report which is customizable by the user.

REPORT CENTER TABLE

| | | |
|---|---|---|
| Main Menu | English (Sel. Lang.) | EST (Sel. Time Zone) |

Date from Date to
Report Type (drop down menu)
Generate Report Selector Function
Select Format Type (HTML, Excel, etc.)

| | | | |
|---|---|---|---|
| Search Term | Sch by Asset | Sel Asset Grp | Sel Div. |

Data Table Part I:

| | | | | | |
|---|---|---|---|---|---|
| Vehicle | Date | Time | Lat | Long | Address |
| (1) Hector | Nov. 15, 2006 | 5:12 PM | 25.94 | 80.15 | 184 NE 23^{rd} |
| | | | | | CT |
| (2) Hector | Nov. 15, 2006 | 5:11 PM | 25.94 | −80.15 | 184 NE 23^{rd} |
| | | | | | Ct. |

Data Table Part II:

| | | | |
|---|---|---|---|
| City | Zip Code | Country | Speed |
| (1) N. Miami | 33160 | USA | 5 |
| (2) N. Miami | 33160 | USA | 0 |

Data Table Part III:

| | | | |
|---|---|---|---|
| Heading | Reason Code | Odometer | mID |
| (1) NW | Start Condition | 0 | 2198744 |
| (2) N | Ignition On | 0 | 2198743 |

This Report Center is properly presented in a landscape format rather than a portrait format. The rows 1 and 2 for vehicle “Hector” are reproduced in the Report Center Table above. Therefore, all the reports associated with Hector are provided to the viewer-user a horizontal or landscape format in the Report Center report. Further customized features include activity, stop-start, speed, idle, drive time, distance traveled, hour worked, geo fence on or off or exceed or redeem, fuel consumption and diagnostics. See FIG. 7B. In addition to the Report Center Table, a report unique to a certain driver may be provided. The following Driver Log Center Table is an example.

DRIVER LOG CENTER TABLE
Human Resource Records for drivers
driver logs
licensing permits
hours, daily, weekly, monthly
signature capture, biometric data capture
pdf driver license and photo
driver certifications
traffic violations
internal report favorable
internal reports unfavorable

This Driver Log includes many features, some of which are human resource records for one or more drivers. Each driver record should have a log identifying the driving time for the driver, over predetermined period of times (days, weeks, months), as well as licensing permits, signature capture and biometric data capture. In handling special goods, it may be necessary to capture signatures showing that a product in transit has been delivered to a certain warehouse or to a certain port. By enabling signature capture data on MDT, and transmitting that signature data to the comm center 10, this feature increases business to business (B-2-B) inventory matters. Biometric data capture involves fingerprint capture (or voice or iris) to turn on and off the truck or to release the load or open a load lock and conduct other activities with respect to the tracked item. Of course voice recognition and an iris scan are also possible biometric characteristics which may be sensed, captured and transmitted to the tracking center 10. Interactive communications links are established between the driver, the tracked item and the comm center 10 by the present invention. If a highly secure load is subject to transport, the center may require a biometric reader prior to initiating a message to permit access to a certain lock or item associated with the tracked device. The Driver Center Log may also include a PDF data scan of the driver's license, certain certificates, traffic violations, internal favorable and unfavorable reports.

### Back Office

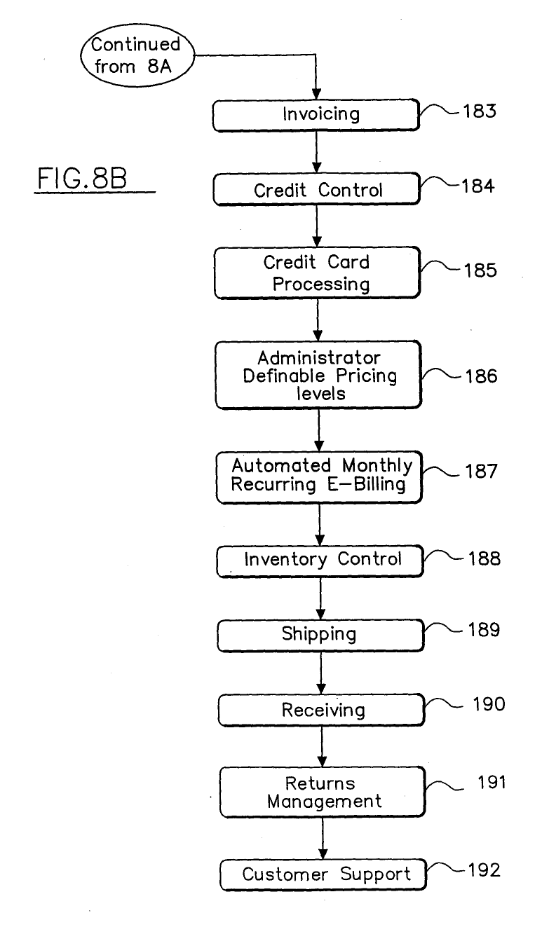

FIGS. 8A and 8B diagrammatically show the functions for a back office for the comm center 10. Some major components of the back office monitor 132 includes account information for the reseller or other customer of comm center 10. A contact and calendar function is provided in 171. Download and collateral information are provided or exchanged in function 173. In other words, the user may want to take an image of a particular truck as it leaves a yard and associate that image of the truck with a record. Function 173 accomplishes that function. Vendor collaboration function 175 indicates that sometimes the comm center is specially configured for a single company and at other times the comm center has listings for “preferred transport companies” which work with a certain customer who wants to transport goods on a regular basis. Vendor collaboration function 175 and customer collaboration 176 enables an increase in business to business communications. Function 177 recognizes that a project manager may be assigned to the system to handle a large group or customer. Catalog shopping cart or management 178 enables goods and services to be bought and sold and transferred through the comm center. Customers my want to buy more tracking devices via comm center 10. Billing engine 180 engages an accounting function and an invoicing function for customers of comm center 10. Purchasing 182 permits the comm center to purchase hardware and software and other items and charge those items to billing engine 180 to customers. Invoicing function 183 and credit control 184 and credit card processing 185 enable the comm center to buy multiple tracking hardware devices, engage the services of telecommunications company for those tracking devices, and deliver goods and services to companies. The return and forwarding of messages and equipment is also noted. All these items are billed to the customer of the tracking comm center. Function 186 defines prices and price levels for resellers of the comm center. Function 187 provides automatic billing of the comm center services to customers. Inventory control 188, shipping 189, receiving 190, return management 191 and customer service function 192 all complement the implementation of the hardware to the customer and to the field.

### Dynamic Aspects of the Present Invention

Throughout this inventive method, the tracking system provides real time information to its customers. This information is real time in that most of this information is as current as possible given the telecommunications channels employed by customer of comm center 10. Many types of tracking devices are pre-programmed to issue a periodic reports to the telecom channel which reports are ultimately picked-up by tracking comm center 10. For example, the tracking device may be set to issue a status signal every 15 minutes indicating its geographic or locus position. The signal would include device id, the address of the tracking comm center, locus data and event time. Other devices can be polled for locus and status. As used herein, a general description of data is provided such that persons of ordinary skill in the art understand the data descriptor used herein. The actual format of the data does change based upon the communications channel and the processing devices and memory devices handling the data. Ultimately, general data descriptions are employed to describe this representative data.

The programming of the tracking devices or modems is sometimes accomplished by the tracking comm center. However, the programming of the tracking devices is less important than the establishment of the data profile for each manufacturer's tracking device such that the tracking comm center 10 can decode the device id, locus data, an event code as that information is collected by the data string profiler 100 in FIG. 4. The data profiler for each type of tracker is available from the manufacturer of that tracker. Manufacturers issue white papers or technical specifications for each device and which list communications protocol or hex string structure which represents the data string output from the tracking device.

With respect to the system, some data processing analysts may view the system as a store and forward data communications device. Voice messages may be stored at the comm center and forwarded to the MTD to be played back by the driver at a certain time.

The following Hex String Data Profiler Table provides examples of tracking devices, data communications profiles, functionality and communications channels associated therewith.

Hex String Data Profiler

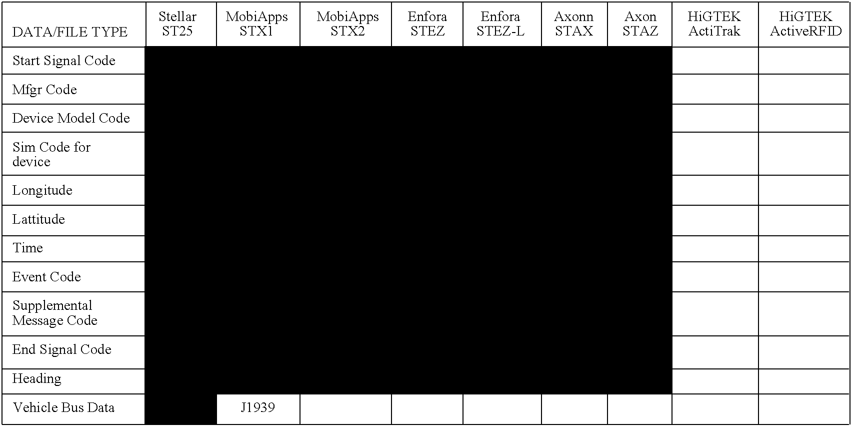

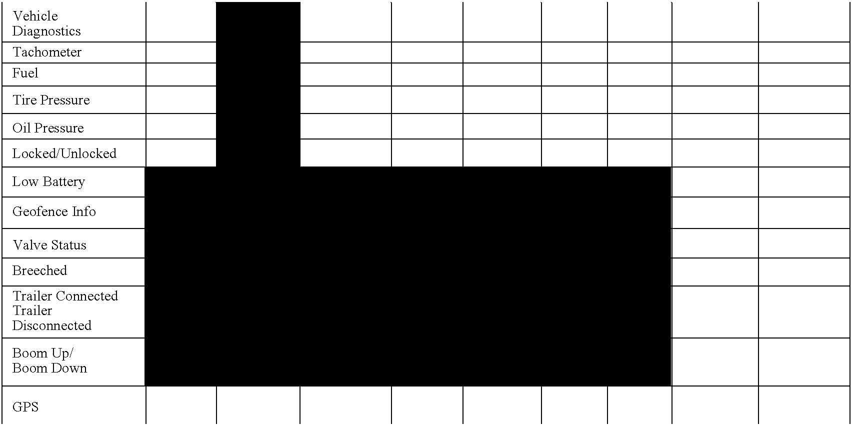

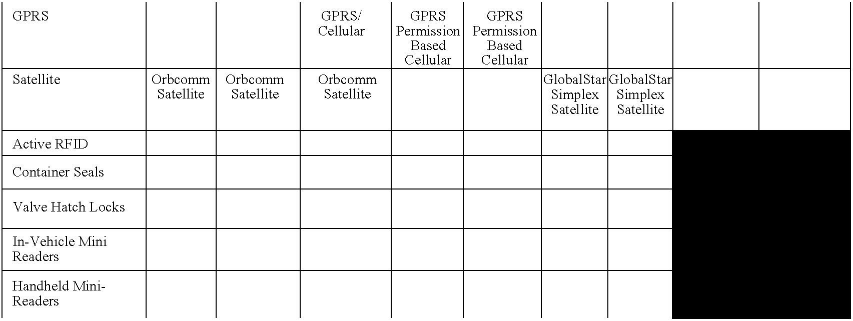

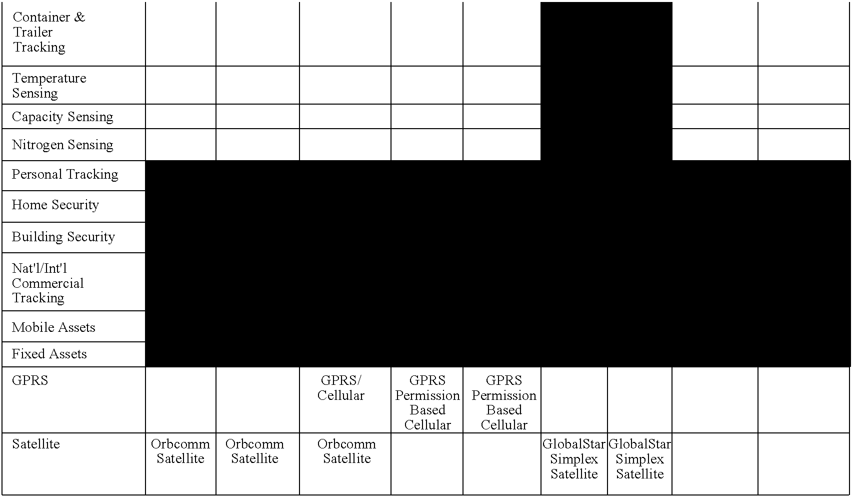

The claims appended hereto are meant to cover modifications and changes within the scope and spirit of the present invention.

What is claimed is:

1. A method of tracking, with a computer system, a plurality oftrackable devices, each trackable: device at least logging and transmitting geographic location or locus data and device identification (id) data unique thereto, the plurality of trackable devices generating and transmitting independent communications packets with addressee data and said unique device id and said logged locus data either periodically or upon command or upon device event into a plurality of communications channels which include GPRS and satellite communications channels, the method of tracking comprising:
compiling tracker device data communications profiles for said plurality oftrackable devices manufactured by a sub-plurality of tracker device manufacturers, each tracker device data communications profile including data field identifiers for said device id data and said logged locus data and at least one event condition data field;
compiling a plurality of customer profiles which correlate sub-pluralities of tracker devices with a corresponding customer of said plurality of customers and, within each said customer profile correlating each tracking device in the respective sub-plurality of tracker devices with a trackable asset owned, controlled or under surveillance by the corresponding customer;
accepting, at a communications port corresponding to said addressee data, said plurality of trackable communications packets;
decoding said plurality oftrackable communications packets with said data communications profiles to ascertain data in fields for said device id data, said logged locus data and said at least one event condition data;
correlating decoded data unique to each trackable communications packet with said customer profiles per the customer trackable asset;
logging and recording the decoded data per said customer profile; and
reporting the logged decoded data per said customer profile.

2. A method of tracking a plurality of trackable devices as claimed in claim 1 wherein said logged locus data includes a time stamp and longitude and latitude, said time stamp decoded and correlated with said customer profiles per the customer trackable asset.

3. A method of tracking a plurality of trackable devices as claimed in claim 1 wherein said logged locus data includes a time stamp and a date and event time, said time stamp date and event time decoded and correlated with said customer profiles per the customer trackable asset.

4. A method of tracking a plurality of trackable devices as claimed in claim 1 including providing a client computer and a server computer, communicatively coupled together, in a web-based server-client computer system and the method includes:
at said server computer:
compiling said tracker device data communications profiles;
compiling said plurality of customer profiles;
accepting said plurality of trackable communications packets;
decoding said plurality of trackable communications packets;
correlating said decoded data;
logging and recording said decoded data per said customer profile; and
sending to said client computer representative data reporting said logged decoded data.

5. A method of tracking a plurality oftrackable devices as claimed in claim 1 wherein reporting includes displaying upon command the logged decoded data.

6. A method of tracking a plurality of trackable devices as claimed in claim 1 wherein a supplemental sub-plurality of said trackable devices generate event codes, said event codes responsive to events or conditions local to a respective one of said sub-plurality of said trackable devices, the method including accepting, decoding, and correlating said event codes from said respective trackable device of said sub-plurality of said trackable devices per said customer profiles.

7. A computerized tracking system operable with a plurality oftrackable devices, each trackable device at least logging and transmitting geographic location or locus data and device identification (id) data unique thereto, the plurality of trackable devices generating and transmitting independent communications packets with addressee data and said unique device id and said logged locus data either periodically or upon command or upon device event into a plurality of communications channels which include GPRS and satellite communications channels, said tracking system communicatively coupled to said plurality of communications channels and comprising:
a data structure containing tracker device data communications profiles for said plurality of trackable devices manufactured by a sub-plurality of tracker device manufacturers, each tracker device data communications profile including data field identifiers for said device id data and said logged locus data and at least one event condition data field;
said data structure also containing compiling a plurality of customer profiles which correlate sub-pluralities of tracker devices with a corresponding customer of said plurality of customers and, within each said customer profile correlating each tracking device in the respective sub-plurality of tracker devices with a trackable asset owned, controlled or under surveillance by the corresponding customer;
a communications port, coupled to said plurality of communications channels, accepting said plurality of trackable communications packets, said communications port associated with said addressee data;
a decoder for said plurality of trackable communications packets, said decoder coupled to said data structure and decoding said trackable communications packets with said data communications profiles to ascertain data in fields for said device id data, said logged locus data and said at least one event condition data;
a processor, coupled to said decoder and said data structure, correlating decoded data unique to each trackable communications packet with said customer profiles per the customer trackable asset and logging the decoded data with said customer profile; and
an output report generator to display, upon commend, the logged decoded data per said customer profile.

8. A computerized tracking system operable with a plurality of trackable devices as claimed in claim 7 wherein said logged locus data includes a time stamp and longitude and latitude, said decoder processing said time stamp to decode and correlate the same with said customer profiles per the customer trackable asset.

9. A computerized tracking system operable with a plurality of trackable devices as claimed in claim 7 wherein said logged locus data includes a time stamp and a date and event time, said decoder processing said time stamp date and event time to decode and correlate the same with said customer profiles per the customer trackable asset.

10. A computerized tracking system operable with a plurality oftrackable devices as claimed in claim 7 including a server computer, operative with said data structure, and the computerized tracking system operable further operative with a plurality of client computers, said server and said plurality of client computers communicatively coupled together, in a web-based server-client computer system, over a global communications network, said server including said output report generator which displays, upon command, the logged decoded data per said customer profile.

11. A computerized tracking system operable with a plurality of trackable devices as claimed in claim 10 wherein said server responds to said commend which commend originates with one of said plurality of client computers.

12. A computer readable medium containing programming instructions for a method of tracking, with a computer system, a plurality of trackable devices, each trackable device at least logging and transmitting geographic location or locus data and device identification (id) data unique thereto, the plurality oftrackable devices generating and transmitting independent communications packets with addressee data and said unique device id and said logged locus data either periodically or upon command or upon device event into a plurality of communications channels which include GPRS and satellite communications channels, the programming instructions for tracking comprising:
compiling tracker device data communications profiles for said plurality oftrackable devices manufactured by a sub-plurality of tracker device manufacturers, each tracker device data communications profile including data field identifiers for said device id data and said logged locus data and at least one event condition data field;
compiling a plurality of customer profiles which correlate sub-pluralities of tracker devices with a corresponding customer of said plurality of customers and, within each said customer profile correlating each tracking device in the respective sub-plurality of tracker devices with a trackable asset owned, controlled or under surveillance by the corresponding customer;
accepting, at a communications port corresponding to said addressee data, said plurality of trackable communications packets;
decoding said plurality oftrackable communications packets with said data communications profiles to ascertain data in fields for said device id data, said logged locus data and said at least one event condition data;
correlating decoded data unique to each trackable communications packet with said customer profiles per the customer trackable asset;
logging and recording the decoded data per said customer profile; and
reporting the logged decoded data per said customer profile.

13. A computer readable medium containing programming instructions for a method of tracking a plurality oftrackable devices as claimed in claim 12 wherein said logged locus data includes a time stamp and longitude and latitude, said time stamp decoded and correlated with said customer profiles per the customer trackable asset.

14. A computer readable medium containing programming instructions for a method of tracking a plurality oftrackable devices as claimed in claim 12 wherein said logged locus data includes a time stamp and a date and event time, said time stamp date and event time decoded and correlated with said customer profiles per the customer trackable asset.

15. A computer readable medium containing programming instructions for a method of tracking a plurality of trackable devices as claimed in claim 12 wherein a client computer and a server computer is provided, said client computer and server computer being communicatively coupled together, in a web-based server-client computer system, and the programming instructions for the method includes:
at said server computer:
compiling said tracker device data communications profiles;
compiling said plurality of customer profiles;
accepting said plurality of trackable communications packets;
decoding said plurality of trackable communications packets;
correlating said decoded data;
logging and recording said decoded data per said customer profile; and
sending to said client computer representative data reporting said logged decoded data.

16. A computer readable medium containing programming instructions for a method of tracking a plurality of trackable devices as claimed in claim 12 wherein reporting includes displaying upon command the logged decoded data.

17. A computer readable medium containing programming instructions for a method of tracking a plurality of trackable devices as claimed in claim 12 wherein a supplemental sub-plurality of said trackable devices generate event codes, said event codes responsive to events or conditions local to a respective one of said sub-plurality of said trackable devices, the method including accepting, decoding, and correlating said event codes from said respective trackable device of said sub-plurality of said trackable devices per said customer profiles.
